(19) United States
(12) Patent Application Publication
(10) Pub. No.: US 2026/0277743 A1
(43) Pub. Date: Sep. 17, 2026

(54) SYSTEM AND METHOD USING STRUCTURAL DATA RECOVERY FRAMEWORK FOR STRUCTURALLY MISSING ELEMENTS VIA MULTI-MATRIX COMPLETION

(71) Applicant: City University of Hong Kong, Hong Kong (HK)

(72) Inventors: Hao Nan SHENG, Hong Kong (HK); Zhi-Yong WANG, Hong Kong (HK); Hing Cheung SO, Hong Kong (HK)

(21) Appl. No.: 19/444,246

(22) Filed: Jan. 9, 2026

Related U.S. Application Data
(60) Provisional application No. 63/770,385, filed on Mar. 12, 2025.

(51) Int. Cl. G06F 11/14

(52) U.S. Cl. CPC G06F 11/1402

(57) ABSTRACT

A structural data recovery processing system includes a data receiver for receiving incomplete matrix-based data sets with missing data entries and an observation and mask handling module for identifying observed data entries and missing data entries within the received data sets. A matrix and tensor structuring module organizes the incomplete data sets into a structured multi-matrix representation based on the identified data entries. An inter-matrix correlation processing module extracts correlation information across multiple matrices. An intra-matrix regularization module characterizes internal structural relationships within individual matrices. A reconstruction update module receives the extracted correlation information and the characterized internal structural relationships to generate reconstructed matrix data through iterative reconstruction updates. An output interface outputs the reconstructed matrix data in a tangible form suitable for storage, display, or transmission. At least a portion of the missing data entries is restored to provide a more complete representation of the input data sets.

### CROSS-REFERENCE TO RELEVANT APPLICATIONS

The present application claims priority from a U.S. provisional patent application Ser. No. 63/770,385 filed Mar. 12, 2025, and the disclosure of which are incorporated by reference in their entirety.

### TECHNICAL FIELD

The present invention generally relates to methods and systems for recovering data elements that are missing in a structured manner within matrix-based datasets. More particularly, the present invention relates to a structural data recovery framework implemented via multi-matrix completion, in which multiple incomplete matrices are jointly processed to restore structurally missing elements.

### BACKGROUND

Matrix completion (MC) exploits the low-rank property of data to recover a matrix from partial observations and has been applied in areas such as image inpainting and recommendation systems. Tensor completion (TC), as an extension of MC to higher dimensions, has been adopted in applications including spectrum cartography and video restoration. Conventional MC and TC techniques generally assume that missing data locations are randomly distributed. In practice, however, missing elements are often non-randomly distributed and may occur as entire missing rows or columns, a condition commonly referred to as structural missingness. Under such circumstances, traditional MC and TC approaches tend to experience significant performance degradation.

Many real-world datasets can be approximately modeled as low-rank matrices, in which a limited number of dominant components contain most of the intrinsic information. Based on this property, low-rank MC aims to recover original data from incomplete observations. Existing MC techniques are generally based on either rank minimization or matrix factorization, and are typically developed under the assumption of randomly missing entries.

In real-world applications, missing data patterns are often more complex and may include structured loss of entire rows or columns. Such structural missingness is commonly encountered in scenarios such as financial reporting, sensor failures in internet-of-things systems, and array element failures in multiple-input multiple-output radar systems. Compared to randomly missing entries, structural entry loss leads to more severe information degradation, and conventional MC methods may become ineffective when attempting to recover entirely missing rows or columns.

Although certain approaches have been proposed to address structural entry loss by incorporating additional constraints or auxiliary information, these techniques often introduce increased design and computational complexity. Moreover, relying solely on correlations within a single matrix is generally insufficient for recovering entire missing rows or columns, while existing tensor-based methods remain limited in handling structural missingness due to insufficient regularization capability.

Therefore, there is a need for improved methods that can effectively handle structural missingness in matrix and tensor completion.

### SUMMARY OF INVENTION

It is an objective of the present invention to provide a system and a method to address the aforementioned shortcomings and unmet needs in the state of the art.

Conventional matrix completion and tensor completion techniques are generally inadequate for recovering data under structural missingness conditions, while existing approaches specifically targeting such scenarios often involve increased design and computational complexity.

The disclosed system and method provide a multiple matrix based framework for recovering structurally missing data elements, in which a plurality of incomplete matrices are jointly processed. In some embodiments, the framework is configured to exploit correlations across different matrices through matrix tri-factorization, and to exploit correlations within individual matrices by applying regularization along matrix rows and columns. The resulting optimization problem may be solved using an alternating direction based optimization scheme. Such a framework is applicable to data recovery tasks including image inpainting and video reconstruction in scenarios involving structured missing entries.

In accordance with a first aspect of the present invention, a structural data recovery processing system for physically processing real-world matrix-based data and restoring structurally missing data elements is provided. The structural data recovery processing system includes a data receiver, an observation and mask handling module, a matrix and tensor structuring module, an inter-matrix correlation processing module, an intra-matrix regularization module, a reconstruction update module, and an output interface. The data receiver is configured to receive one or more incomplete matrix-based data sets containing missing data entries. The observation and mask handling module is communicatively coupled to the data receiver and is configured to identify observed data entries and missing data entries within the received incomplete matrix-based data sets to generate identification information. The matrix and tensor structuring module is communicatively coupled to the observation and mask handling module and is configured to organize the received incomplete matrix-based data sets into a structured multi-matrix representation in response to the identification information. The inter-matrix correlation processing module is communicatively coupled to the matrix and tensor structuring module and is configured to extract correlation information across multiple matrices from the structured multi-matrix representation. The intra-matrix regularization module is communicatively coupled to the matrix and tensor structuring module and is configured to characterize internal structural relationships within individual matrices based on matrix-level data from the structured multi-matrix representation. The reconstruction update module is communicatively coupled to the inter-matrix correlation processing module and the intra-matrix regularization module. The reconstruction update module is configured to receive the extracted correlation information and the characterized internal structural relationships so as to generate reconstructed matrix data based thereon via one or more reconstruction updates. The output interface is communicatively coupled to the reconstruction update module and is configured to output the reconstructed matrix data in a tangible form suitable for storage, display, or transmission.

In accordance with a second aspect of the present invention, a structural data recovery method for physically processing real-world matrix-based data and restoring structurally missing data elements is provided. The structural data recovery method includes steps as follows: identifying, by an observation and mask handling module, observed data entries and missing data entries within incomplete matrix-based data sets to generate identification information; organizing, by a matrix and tensor structuring module, the incomplete matrix-based data sets into a structured multi-matrix representation in response to the identification information; extracting, by an inter-matrix correlation processing module, correlation information across multiple matrices from the structured multi-matrix representation; characterizing, by an intra-matrix regularization module, internal structural relationships within individual matrices based on matrix-level data derived from the structured multi-matrix representation; receiving, by a reconstruction update module, the extracted correlation information and the characterized internal structural relationships so as to generate reconstructed matrix data based thereon via one or more reconstruction updates; and outputting, by an output interface, the reconstructed matrix data in a tangible form suitable for storage, display, or transmission.

Through the foregoing provided features, the disclosed system and method achieve the following technical advantages:
(I): A multi-matrix completion framework is provided for jointly processing a plurality of matrices having randomly missing entries and structurally missing entries. In the provided framework, correlations across different matrices are exploited through matrix tri-factorization, while correlations within each individual matrix are exploited by applying regularization along matrix rows and columns, thereby supporting recovery of structurally missing data elements and extending applicability beyond matrix completion and tensor completion techniques designed primarily for random missingness.
(II): The multi-matrix completion framework does not require smoothness assumptions across matrices along a temporal or sequential dimension, and is therefore applicable to non-smooth data configurations, including time-disordered image sequences and combinations of different images or videos.
(III): Computational sequences generated during the data recovery process are bounded, and convergence of the recovery process may be characterized by a stable solution, thereby supporting practical implementation of the provided framework.
(IV): The provided framework is applicable to data recovery tasks such as image inpainting and video reconstruction, particularly in scenarios involving structurally missing data elements.

### BRIEF DESCRIPTION OF DRAWINGS

Embodiments of the invention are described in more details hereinafter with reference to the drawings, in which:

FIG. 1 shows a multi-matrix completion (MMC) framework according to some embodiments of the present invention;

FIG. 2 shows Algorithm 1 for an example MMC procedure according to some embodiments of the present invention;

FIG. 3 shows a comparison between smooth data and non-smooth data scenarios in a multi-matrix data recovery process;

FIG. 4 shows different images with missing data patterns I and II according to some embodiments of the present invention;

FIG. 5 shows multiple image inpainting results with randomly missing entries according to some embodiments of the present invention;

FIG. 6 shows multiple image inpainting results with randomly and structurally missing entries according to some embodiments of the present invention;

FIG. 7 shows PSNR and SSIM versus observation percentage Oₚ according to some embodiments of the present invention, containing part (a) and part (b);

FIG. 8 shows example comparative performance results of a MMC framework with respect to face restoration quality and face recognition accuracy;

FIG. 9 shows video restoration results according to some embodiments of the present invention; and

FIG. 10 illustrates a block diagram for an architecture of a structural data recovery processing system using a multi-matrix processing framework according to some embodiments of the present invention.

### DETAILED DESCRIPTION OF THE INVENTION

In the following description, systems and methods for structurally missing elements via multi-matrix completion and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The disclosed system and method are generally directed to recovering a plurality of matrices from partial observations, particularly in scenarios where entire rows and/or columns of data are missing. While image inpainting and video restoration are representative application examples, the underlying data recovery problem is also encountered in a wide range of scientific and engineering fields, including localization of internet-of-things networks, recommendation systems, complex survey sampling, radio map reconstruction, econometrics, and multiple-input multiple-output radar target parameter estimation.

The following description provides technical background and related concepts to facilitate understanding of the disclosed subject matter, and is further organized to present theoretical considerations and practical implementations. In particular, system architectures and corresponding embodiments are described to illustrate how the disclosed framework may be implemented in various application scenarios.

### A. Prior Arts on Matrix Completion and Tensor Completions

MC seeks a matrix X∈ [symbol] to approximate a low-rank matrix L∈ [symbol] using its partial observations:

$${min}_{X} rank ( X ) , s . t . {X}_{Ω} = {L}_{Ω} \qquad ( 1 )$$

which is called the rank minimization formulation. Since the equation (1) is a NP-hard problem, the rank function is practically relaxed to the nuclear norm:

$${min}_{X} {‖ X ‖}_{*} , s . t . {X}_{Ω} = {L}_{Ω} \qquad ( 2 )$$

Nonetheless, solving the equation (2) is still expensive since SVD is involved. Alternatively, by leveraging matrix factorization, the MC problem becomes:

$${min}_{U , V} {‖ {L}_{Ω} - {( U V )}_{Ω} ‖}_{F}^{2} \qquad ( 3 )$$

where U∈ [symbol] , V∈ [symbol] , and r is the rank of L, which is required to be known.

As an extension of MC to higher dimensional space, TC can also be formulated as a tubal rank minimization problem:

$${min}_{χ} {rank}_{t} ( χ ) , s . t . {χ}_{Ω} = {L}_{Ω} \qquad ( 4 )$$

where rankₜ(·) is the tensor tubal rank and χ, [symbol] ∈ [symbol] , (only third-order tensor is considered in this patent). Since solving the equation (4) is also not feasible, the rank function is replaced by tensor nuclear norm (TNN), denoted by ∥·∥_{TNN}:

$${min}_{χ} {‖ χ ‖}_{TNN} , s . t . {χ}_{Ω} = {L}_{Ω} \qquad ( 5 )$$

The corresponding algorithm is referred to as t-SVD, which implements SVD in the Fourier domain. To alleviate the computational burden caused by multiple SVDs, TC by tensor factorization (TCTF) performs matrix factorization in the Fourier domain, whose formulation is:

$${min}_{𝒰 , 𝒱} {‖ {L}_{Ω} - {( 𝒰 * 𝒱 )}_{Ω} ‖}_{F}^{2} \qquad ( 6 )$$

where * denotes the t-product while [symbol] ∈ [symbol] and [symbol] ∈ [symbol] with \hat{r} being the estimate of tubal rank.

However, these schemes work under the assumption that the missing locations are sampled at random, and may degrade significantly if structural missingness is present.

### B. The Multi-Matrix Completion Algorithm

To exploit both inter-matrix and inner-matrix correlations, the following formulation is proposed:

$${min}_{U , {\{ {S}_{k} \}}_{k = 1}^{K} , V} {\sum }_{k = 1}^{K} {‖ {X}_{k} - U {S}_{k} {V}^{T} ‖}_{{Ω}_{k}}^{2} + λ {‖ LU {S}_{k} {V}^{T} ‖}_{F}^{2} + λ {‖ {US}_{k} {V}^{T} R ‖}_{F}^{2} , \\ s . t . {U}^{T} U = {V}^{T} V = {I}_{r} \qquad ( 7 )$$

where

$${\{ {X}_{k} \}}_{k = 1}^{K}$$

is the underlying matrix sequence, U and V are semi-unitary matrices as in the generalized low-rank approximations of matrices (GLRAM), and USₖV^{T} is the reconstruction for Xₖ. ∥·∥_{Ω}_{ₖ} denotes ∥(·)_{Ω}_{ₖ}∥_{F} for simplicity. In the equation (7), the first term deals with the inter-matrix correlations using tri-factorization which can be considered as a modified version of GLRAM for the missing data scenario. It aims to learn the bases for common column and row spaces U and V from all underlying matrices. The second and third terms are responsible for inner-matrix correlations to further refine USₖV^{T}. Here, L∈ [symbol] and R∈ [symbol] are discrete approximations to the derivative operator. Tikhonov regularization is a representative approach that is widely used in ill-posed problems. To perform first-order forward differencing, its left-side and right-side difference matrices are:

$$L = [ \begin{matrix}1 & - 1 & 0 & … & 0 \\ 0 & 1 & - 1 & ⋱ & ⋮ \\ ⋮ & ⋱ & ⋱ & ⋱ & 0 \\ 0 & … & 0 & 1 & - 1\end{matrix} ] ∈ \text{?} , \\ R = [ \begin{matrix}- 1 & 0 & … & 0 \\ 1 & - 1 & ⋱ & ⋮ \\ 0 & 1 & ⋱ & 1 \\ ⋮ & ⋱ & ⋱ & - 1 \\ 0 & … & 0 & 1\end{matrix} ] ∈ \text{?} \qquad ( 8 )$$

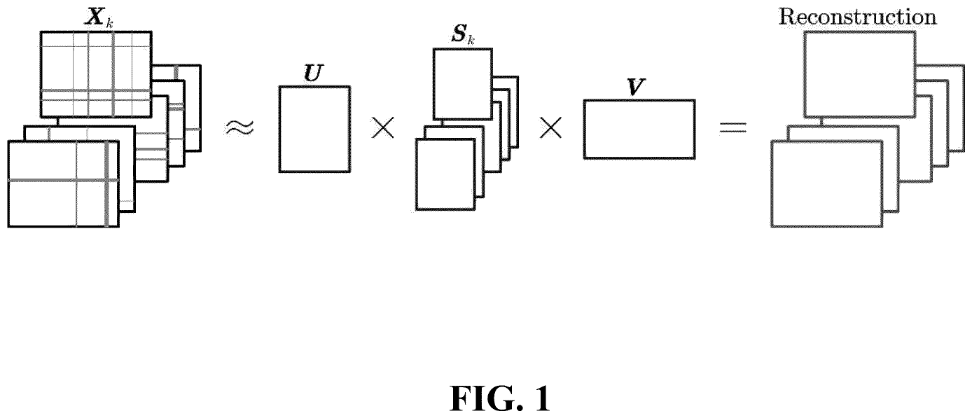

The L smooths adjacent rows in USₖV^{T}, meaning that missing rows will obtain information from their neighboring rows while R smooths adjacent columns in USₖV^{T}, indicating that missing columns are reconstructed with the use of their neighboring columns. While the user-defined parameter λ>0 controls the degree of smoothing. Consequently, the proposed framework can leverage both inter-matrix and inner-matrix correlations, and is able to restore a sequence of underlying matrices with structurally missing elements, as illustrated in FIG. 1, which shows a multi-matrix completion (MMC) framework according to some embodiments of the present invention.

Unlike SVD, all underlying matrices in MMC share the same U and V, alleviating the latter computational load. Notably, even for the limiting scenario of a single matrix, structural incompleteness can still be tackled, thanks to the incorporation of the Tikhonov regularization term.

In order to get rid of the sampling operator (·)_{Ω}_{ₖ} and thereby facilitate handling the first term, an auxiliary variable X_{Ω}_{^{c}}ₖ is introduced, then the equation (7) becomes:

$${min}_{{\{ {S}_{k} , {X}_{{Ω}^{c} k} \}}_{k = 1}^{K} , U , V} {\sum }_{k = 1}^{K} {‖ {X}_{Ω k} + {X}_{{Ω}^{c} k} - U {S}_{k} {V}^{T} ‖}_{{Ω}_{k}}^{2} + λ {‖ LU {S}_{k} {V}^{T} ‖}_{F}^{2} + λ {‖ {US}_{k} {V}^{T} R ‖}_{F}^{2} , \\ s . t . {U}^{T} U = {V}^{T} V = {I}_{r} , {( {X}_{{Ω}^{c} k} )}_{{Ω}_{k}} \qquad ( 9 )$$

where X_{Ωk} stands for (Xₖ)_{Ω}_{ₖ} for brevity.

Then, the equation (9) is solved by ADMM. To decompose the primal problem, ADMM introduces two auxiliary variable sequences

$${\{ {Y}_{Ω k} \}}_{k = 1}^{K} and {\{ {Z}_{Ω k} \}}_{k = 1}^{K} .$$

As a result, the equation (9) is rewritten as:

$${min}_{{\{ {X}_{Ω} {c}_{k} , {Y}_{k} , {Z}_{k} , {S}_{k} \}}_{k = 1}^{K} , U , V} {\sum }_{k = 1}^{K} {‖ {X}_{Ω k} + {X}_{{Ω}^{c} k} - {Y}_{k} ‖}_{{Ω}_{k}}^{2} + λ {‖ {LY}_{k} ‖}_{F}^{2} + λ {‖ {Z}_{k} R ‖}_{F}^{2} , \\ s . t . {( {X}_{{Ω}^{c} k} )}_{{Ω}_{k}} = 0 , {Y}_{k} = {US}_{k} {V}^{T} , {Z}_{k} = {Y}_{k} , {U}^{T} U = {V}^{T} V = {I}_{r} \qquad ( 10 )$$

The corresponding augmented Lagrangian is:

$${min}_{Φ} {\sum }_{k = 1}^{K} {‖ {X}_{Ω k} + {X}_{{Ω}^{c} k} - {Y}_{k} ‖}_{{Ω}_{k}}^{2} + λ {‖ {LY}_{k} ‖}_{F}^{2} + λ {‖ {Z}_{k} R ‖}_{F}^{2} + 〈 {P}_{k} , {Y}_{k} - {US}_{k} {V}^{T} 〉 + \frac{ρ}{2} {‖ {Y}_{k} - {US}_{k} {V}^{T} ‖}_{F}^{2} + 〈 {Q}_{k} , {Z}_{k} - {Y}_{k} 〉 + \frac{ρ}{2} {‖ {Y}_{k} - {Z}_{k} ‖}_{F}^{2} , Φ := {\{ {X}_{{Ω}^{c} k} , {Y}_{k} , {Z}_{k} , {S}_{k} , {P}_{k} , {Q}_{k} \}}_{k = 1}^{K} , U , V \\ s . t . {U}^{T} U = {V}^{T} V = {I}_{r} , {( {X}_{{Ω}^{c} k} )}_{{Ω}_{k}} = 0 \qquad ( 11 )$$

where [symbol] · [symbol] represents the inner product of two matrices, Pₖ and Qₖ are Lagrange multiplier matrices, ρ>0 is the augmented Lagrangian parameter. Then, the primal and dual variables are updated in an iterative and alternating manner as follows.

Step 1: At the (i+1)th iteration, given the estimate of Yₖ at the ith iteration, denoted by

$${Y}_{k}^{i} , U , {\{ {S}_{k} \}}_{k = 1}^{K} ,$$

V are obtained from:

$${min}_{U , {\{ {S}_{k} \}}_{k = 1}^{K} , V} {\sum }_{k = 1}^{K} 〈 {P}_{k}^{i} , {Y}_{k}^{i} - U {S}_{k} {V}^{T} 〉 + \frac{ρ}{2} {‖ {Y}_{k}^{i} - {US}_{k} {V}^{T} ‖}_{F}^{2} s . t . {U}^{T} U = {V}^{T} V = {I}_{r} \qquad ( 12 )$$

With some manipulations, the equation (12) becomes:

$${min}_{U , {\{ {S}_{k} \}}_{k = 1}^{K} , V} {\sum }_{k = 1}^{K} {‖ {Y}_{k}^{i} + \frac{1}{ρ} {P}_{k}^{i} - U {S}_{k} {V}^{T} ‖}_{F}^{2} s . t . {U}^{T} U = {V}^{T} V = {I}_{r} \qquad ( 13 )$$

Since it is assumed that X_{Ωk} contains no noise, the observed entries in (USₖV)_{Ω}_{ₖ} should approximate X_{Ωk} more, and therefore

$${( {Y}_{k}^{i} + \frac{1}{ρ} {P}_{k}^{i} )}_{{Ω}_{k}} = {X}_{Ω k}$$

is set at the end of each iteration. Accordingly, the equation (13) is modified as:

$${min}_{U , {\{ {S}_{k} \}}_{k = 1}^{K} , V} {\sum }_{k = 1}^{K} {‖ {x}_{Ω k} + {( {Y}_{k}^{i} + \frac{1}{ρ} {P}_{k}^{i} )}_{{Ω}_{k}^{c}} - U {S}_{k} {V}^{T} ‖}_{F}^{2} s . t . {U}^{T} U = {V}^{T} V = {I}_{r} \qquad ( 14 )$$

Here,

$${U}^{i + 1} , {\{ {S}_{k}^{i + 1} \}}_{k = 1}^{K} ,$$

and Vⁱ⁺¹ are obtained by GLRAM with the input being

$${\{ {A}_{k}^{i} \}}_{k = 1}^{K} = {\{ {X}_{Ω k} + {( {Y}_{k}^{i} + \frac{1}{ρ} {P}_{k}^{i} )}_{{Ω}_{k}^{c}} \}}_{k = 1}^{K} ,$$

where Uⁱ⁺¹ is composed of the eigenvectors corresponding to the r largest eigenvalues of

$${\sum }_{k = 1}^{K} {A}_{k}^{i} {V}^{i} {V}^{i T} {A}_{k}^{i T}$$

and Vⁱ⁺¹ is composed of the eigenvectors corresponding to the c largest eigenvalues of

$${\sum }_{k = I}^{K} {A}_{k}^{i T} {U}^{i + 1} {U}^{i + 1 T} {A}_{k}^{i} .$$

Consequently, the unitary matrix constraints on U and V are naturally met. Next,

$${S}_{k}^{i + 1}$$

is computed as

$${S}_{k}^{i + 1} = {U}^{i + 1 T} {A}_{k}^{i} {V}^{i + 1} .$$

Step 2: Given

$${U}^{i + 1} , {\{ {S}_{k}^{i + 1} \}}_{k = 1}^{K} , and {V}^{i + 1} , {Y}_{k}^{i + 1}$$

with different index k can be computed separately in a sequential manner since they are not coupled, namely:

$${Y}_{k}^{i + 1} = arg {min}_{{Y}_{k}} {‖ {X}_{{Ω}_{k}} + {X}_{{Ω}^{c} k} - {Y}_{k} ‖}_{F}^{2} + λ {‖ L {Y}_{k} ‖}_{F}^{2} + 〈 {P}_{k} , {Y}_{k} - U {S}_{k} {V}^{T} 〉 + \frac{ρ}{2} {‖ {Y}_{k} - U {S}_{k} {V}^{T} ‖}_{F}^{2} + 〈 {Q}_{k} , {Z}_{k} - {Y}_{k} 〉 + \frac{ρ}{2} {‖ {Z}_{k} - {Y}_{k} ‖}_{F}^{2} = > {{Y}_{k}^{i + {1}_{=}} [ ( 2 + 2 ρ ) {I}_{m} + 2 λ {L}^{T} L ]}^{- 1} \cdot ( 2 {X}_{Ω k} + 2 {X}_{{Ω}^{c} k}^{i} + ρ {Z}_{k}^{i} - {P}_{k}^{i} + {Q}_{k}^{i} + ρ {U}^{i + 1} {S}_{k}^{i + 1} {V}^{i + 1 T} ) \qquad ( 15 )$$

Step 3:

$${\{ {X}_{{Ω}^{c} k}^{i + 1} \}}_{k = 1}^{K}$$

are updated as:

$$( 16 )$$

$${X}_{{Ω}^{c} k}^{i + 1} = arg {min}_{{X}_{Ω} {c}_{k}} {‖ {X}_{Ω k} + {X}_{{Ω}^{c} k} - {Y}_{k} ‖}_{F}^{2} , s . t . {( {X}_{{Ω}^{c} k} )}_{Ω k} = 0 = > {X}_{{Ω}^{c} k}^{i + 1} = {( {Y}_{k}^{i + 1} )}_{{Ω}^{c}}$$

Step 4: Update the dual variables

$${\{ {P}_{k}^{i + 1} \}}_{k = 1}^{K}$$

using gradient ascent:

$${P}_{k}^{i + 1} = {P}_{k}^{i} + ρ ( {Y}_{k}^{i + 1} - {U}^{i + 1} {S}_{k}^{i + 1} {V}^{i + 1 T} ) \qquad ( 17 )$$

Step 5: Calculate

$${\{ {Z}_{k}^{i + 1} \}}_{k = 1}^{K}$$

in the same manner as

$${\{ {Y}_{k}^{i + 1} \}}_{k = 1}^{K} :$$

$${Z}_{k}^{i + 1} = arg {min}_{{Z}_{k}} λ {‖ {Z}_{k} R ‖}_{F}^{2} + 〈 {Q}_{k}^{i} , {Z}_{k} - {Y}_{k}^{i + 1} 〉 + \frac{ρ}{2} {‖ {Z}_{k} - {Y}_{k}^{i + 1} ‖}_{F}^{2} = > {Z}_{k}^{i + 1} = ( ρ {Y}_{k}^{i + 1} - {Q}_{k}^{i} ) {( 2 λ R {R}^{T} + ρ {I}_{n} )}^{- 1} \qquad ( 18 )$$

Step 6: Update the dual variables

$${\{ {Q}_{k}^{i + 1} \}}_{k = 1}^{K}$$

by:

$${Q}_{k}^{i + 1} = {Q}_{k}^{i} + ρ ( {Z}_{k}^{i + 1} - {Y}_{k}^{i + 1} ) \qquad ( 19 )$$

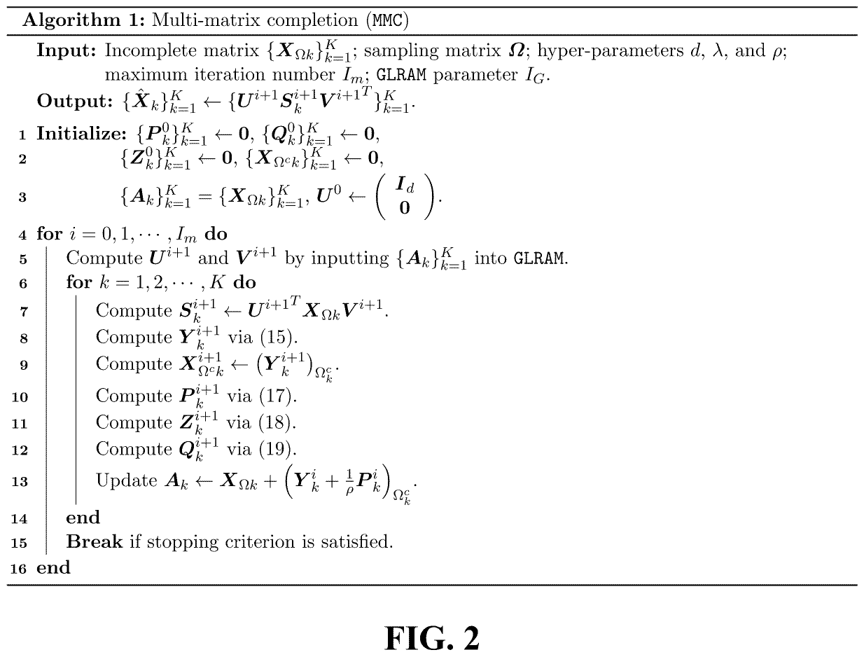

After K inner cycles, the algorithm will enter the (i+2)th iteration and repeat the above steps until a stopping criterion is met. As shown in FIG. 2, all detailed steps are provided in Algorithm 1.

Remark I: Fourier transform based methods such as t-SVD and TCTF exploit the inherent low-rank structure of a tensor in the Fourier domain, facilitating them to handle grayscale videos, RGB images, etc., but they are also dependent on the time continuity along the third dimension to ensure the low-rank structure. Here, time continuity refers to the smooth change of data.

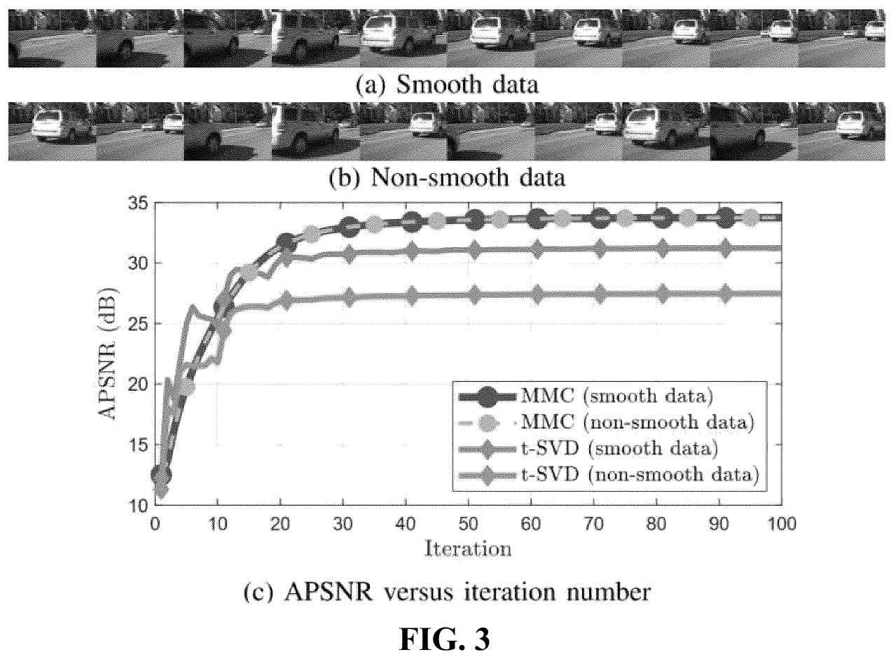

FIG. 3 illustrates a comparison between smooth data and non-smooth data scenarios in a multi-matrix data recovery process, in which part (a) shows an example of smooth data, part (b) shows an example of non-smooth data, and part (c) shows a plot of average peak signal-to-noise ratio (APSNR) versus iteration number for different data recovery approaches under smooth and non-smooth conditions.

In FIG. 3, part (a) and part (b) provide examples for smooth data with time continuity and non-smooth data which are time-disordered, respectively. Non-smoothness along the third dimension may lead to an increase in high-frequency components in the Fourier domain, thereby undermining the low-rank structure. Employing the grayscale versions of part (a) and part (b) of FIG. 3 as input to t-SVD, average peak signal-to-noise ratio (APSNR) versus number of iterations is plotted in part (c) of FIG. 3, demonstrating its performance degradation when encountering non-smooth data.

Aside from the superiority in recovering structural missing data, MMC differs significantly from Fourier transform based methods such as t-SVD and TCTF because it does not require time continuity along the third dimension. MMC works in the original domain, and its performance is independent of whether the data are smooth or not. As a quick comparison, part (c) of FIG. 3 also plots the APSNR for MMC. It is seen that the MMC does not necessitate the smoothness along the third dimension, that is, time-disordered data are recovered almost identically to time-ordered data.

### C. Convergence Analysis

All the variables at the ith iteration are group as:

$${Φ}^{i} := \{ {\{ {X}_{{Ω}^{c} k}^{i} , {Y}_{k}^{i} , {Z}_{k}^{i} , {S}_{k}^{i} , {P}_{k}^{i} , {Q}_{k}^{i} \}}_{k = 1}^{K} , {U}^{i} , {V}^{i} \} , \qquad ( 20 )$$

$$and :$$

$$( 21 )$$

$$ℱ ( {Φ}^{i} ) := {‖ {X}_{Ω k} + {X}_{{Ω}^{c} k}^{i} - {Y}_{k}^{i} ‖}_{F}^{2} + λ {‖ {LY}_{k}^{i} ‖}_{F}^{2} + λ {‖ {Z}_{k}^{i} R ‖}_{F}^{2} + 〈 {P}_{k}^{i} , {Y}_{k}^{i} - {U}^{i} {S}_{k}^{i} {V}^{i T} 〉 + \frac{ρ}{2} {‖ {Y}_{k}^{i} - {U}^{i} {S}_{k}^{i} {V}^{i T} ‖}_{F}^{2} + 〈 {Q}_{k}^{i} , {Z}_{k}^{i} - {Y}_{k}^{i} 〉 + \frac{ρ}{2} {‖ {Z}_{k}^{i} - {Y}_{k}^{i} ‖}_{F}^{2}$$

Due to the presence of Lagrange multipliers, analyzing the convergence of [symbol] (Φⁱ) is challenging despite empirical convergence is observed in part (c) of FIG. 2. Therefore, the convergence of [symbol] (Φⁱ) is not proved directly, but an auxiliary function [symbol] (Φⁱ, \tilde{Y}, \tilde{Z}) instead. The proof is provided in Lemma 1.

Lemma 1: it is defined:

$$\tilde{ℱ} ( {Φ}^{i} , \tilde{Y} , \tilde{Z} ) := ℱ ( {Φ}^{i} ) + \frac{16}{ρ} {‖ {Y}_{k}^{i} - \tilde{Y} ‖}_{F}^{2} + 4 ρ {‖ {Z}_{k}^{i} - \tilde{Z} ‖}_{F}^{2} \qquad ( 22 )$$

which satisfies:

$$\tilde{ℱ} ( {Φ}^{i + 1} , {Y}_{k}^{i} , {Z}_{k}^{i} ) - \tilde{ℱ} ( {Φ}^{i} , {Y}_{k}^{i - 1} , {Z}_{k}^{i - 1} ) \leq {p}_{1} {‖ {Y}_{k}^{i + 1} - {Y}_{k}^{i} ‖}_{F}^{2} + {p}_{2} {‖ {Z}_{k}^{i + 1} - {Z}_{k}^{i} ‖}_{F}^{2} < 0 \qquad ( 23 )$$

$$where :$$

$${p}_{1} = - \{ \frac{4}{ρ} [ {( 2 + ρ + 2 λ {λ}_{m} )}^{2} + 4 ] - \frac{1 + ρ}{2} \}$$

$${p}_{2} = - [ \frac{20}{ρ} {λ}^{2} {λ}_{m}^{2} + \frac{7 ρ}{2} ] \qquad ( 24 )$$

Proof: Denote the augmented Lagrangian in the equation (21) as

$$ℱ ( {\{ {X}_{{Ω}^{c} k} , {Y}_{k} , {Z}_{k} , {S}_{k} , {P}_{k} , {Q}_{k} \}}_{k = 1}^{K} , U , V ) .$$

Only the kth inner cycle is considered for simplicity.

According to GLRAM, U, Sₖ, V are the optimal solutions to the equation (13), hence it is known that:

$$ℱ ( {X}_{{Ω}^{c} k}^{i} , {Y}_{k}^{i} , {Z}_{k}^{i} , {S}_{k}^{i + 1} , {P}_{k}^{i} , {Q}_{k}^{i} , {U}^{i + 1} , {V}^{i + 1} ) \leq ℱ ( {X}_{{Ω}^{c} k}^{i} , {Y}_{k}^{i} , {Z}_{k}^{i} , {S}_{k}^{i} , {P}_{k}^{i} , {Q}_{k}^{i} , {U}^{i} , {V}^{i} ) \qquad ( 25 )$$

$${Y}_{k}^{i + 1}$$

is the optimal solution to the equation (15) and

$$ℱ ( {X}_{{Ω}^{c} k}^{i} , {Y}_{k} , {Z}_{k}^{i} , {S}_{k}^{i + 1} , {P}_{k}^{i} , {Q}_{k}^{i} , {U}^{i + 1} , {V}^{i + 1} )$$

is (1+ρ)-strongly convex with respect to Yₖ, hence it is obtained that:

$$ℱ ( {X}_{{Ω}^{c} k}^{i} , {Y}_{k}^{i + 1} , {Z}_{k}^{i} , {S}_{k}^{i + 1} , {P}_{k}^{i} , {Q}_{k}^{i} , {U}^{i + 1} , {V}^{i + 1} ) \leq ℱ ( {X}_{{Ω}^{c} k}^{i} , {Y}_{k}^{i} , {Z}_{k}^{i} , {S}_{k}^{i + 1} , {P}_{k}^{i} , {Q}_{k}^{i} , {U}^{i + 1} , {V}^{i + 1} ) - \frac{1 + ρ}{2} {‖ {Y}_{k}^{i + 1} - {Y}_{k}^{i} ‖}_{F}^{2} \qquad ( 26 )$$

Similarly, for

$${X}_{k}^{i + 1} ,$$

it is held that:

$$ℱ ( {X}_{{Ω}^{c} k}^{i + 1} , {Y}_{k}^{i + 1} , {Z}_{k}^{i} , {S}_{k}^{i + 1} , {P}_{k}^{i} , {Q}_{k}^{i} , {U}^{i + 1} , {V}^{i + 1} ) \leq ℱ ( {X}_{{Ω}^{c} k}^{i} , {Y}_{k}^{i + 1} , {Z}_{k}^{i} , {S}_{k}^{i + 1} , {P}_{k}^{i} , {Q}_{k}^{i} , {U}^{i + 1} , {V}^{i + 1} ) \qquad ( 27 )$$

Moreover, for

$${P}_{k}^{i + 1} ,$$

it is held that:

$$ℱ ( {X}_{{Ω}^{c} k}^{i + 1} , {Y}_{k}^{i + 1} , {Z}_{k}^{i} , {S}_{k}^{i + 1} , {P}_{k}^{i + 1} , {Q}_{k}^{i} , {U}^{i + 1} , {V}^{i + 1} ) - ℱ ( {X}_{{Ω}^{c} k}^{i + 1} , {Y}_{k}^{i + 1} , {Z}_{k}^{i} , {S}_{k}^{i + 1} , {P}_{k}^{i} , {Q}_{k}^{i} , {U}^{i + 1} , {V}^{i + 1} ) = 〈 {P}_{k}^{i + 1} , {Y}_{k}^{i + 1} - {U}^{i + 1} {S}_{k}^{i + 1} {V}^{i + 1 T} 〉 - 〈 {P}_{k}^{i} , {Y}_{k}^{i + 1} - {U}^{i + 1} {S}_{k}^{i + 1} {V}^{i + 1 T} 〉 = {Tr ( {P}_{k}^{i + 1} - {P}_{k}^{i} )}^{T} ( {Y}_{k}^{i + 1} - {U}^{i + 1} {S}_{k}^{i + 1} {V}^{i + 1 T} ) = \frac{1}{ρ} T {r ( {P}_{k}^{i + 1} - {P}_{k}^{i} )}^{T} ( {P}_{k}^{i + 1} - {P}_{k}^{i} ) = \frac{1}{ρ} {‖ {P}_{k}^{i + 1} - {P}_{k}^{i} ‖}_{F}^{2} \qquad ( 28 )$$

$$ℱ ( {X}_{{Ω}^{c} k}^{i} , {Y}_{k} , {Z}_{k}^{i} , {S}_{k}^{i + 1} , {P}_{k}^{i} , {Q}_{k}^{i} , {U}^{i + 1} , {V}^{i + 1} )$$

is ρ-strongly convex with respect to Zₖ:

$$ℱ ( {X}_{{Ω}^{c} k}^{i + 1} , {Y}_{k}^{i + 1} , {Z}_{k}^{i + 1} , {S}_{k}^{i + 1} , {P}_{k}^{i + 1} , {Q}_{k}^{i} , {U}^{i + 1} , {V}^{i + 1} ) \leq ℱ ( {X}_{{Ω}^{c} k}^{i + 1} , {Y}_{k}^{i + 1} , {Z}_{k}^{i} , {S}_{k}^{i + 1} , {P}_{k}^{i + 1} , {Q}_{k}^{i} , {U}^{i + 1} , {V}^{i + 1} ) - \frac{ρ}{2} {‖ {Z}_{k}^{i + 1} - {Z}_{k}^{i} ‖}_{F}^{2} \qquad ( 29 )$$

Last, similar with

$${Q}_{k}^{i + 1}$$

it is known for

$${P}_{k}^{i + 1} ,$$

that:

$$( 30 )$$

$$ℱ ( {X}_{{Ω}^{c} k}^{i + 1} , {Y}_{k}^{i + 1} , {Z}_{k}^{i + 1} , {S}_{k}^{i + 1} , {P}_{k}^{i + 1} , {Q}_{k}^{i + 1} , {U}^{i + 1} , {V}^{i + 1} ) - ℱ ( {X}_{{Ω}^{c} k}^{i + 1} , {Y}_{k}^{i + 1} , {Z}_{k}^{i + 1} , {S}_{k}^{i + 1} , {P}_{k}^{i + 1} , {Q}_{k}^{i} , {U}^{i + 1} , {V}^{i + 1} ) = 〈 {Q}_{k}^{i + 1} , {Z}_{k}^{i + 1} - {Y}_{k}^{i + 1} 〉 - 〈 {Q}_{k}^{i + 1} , {Z}_{k}^{i + 1} - {Y}_{k}^{i + 1} 〉 = {Tr ( {Q}_{k}^{i + 1} - {Q}_{k}^{i} )}^{T} ( {Z}_{k}^{i + 1} - {Y}_{k}^{i + 1} ) = \frac{1}{ρ} {Tr ( {Q}_{k}^{i + 1} - {Q}_{k}^{i} )}^{T} ( {Q}_{k}^{i + 1} - {Q}_{k}^{i} ) = \frac{1}{ρ} {‖ {Q}_{k}^{i + 1} - {Q}_{k}^{i} ‖}_{F}^{2}$$

Merging the equations (25) to (30) yields:

$$( 31 )$$

$$ℱ ( {X}_{{Ω}^{c} k}^{i + 1} , {Y}_{k}^{i + 1} , {Z}_{k}^{i + 1} , {S}_{k}^{i + 1} , {P}_{k}^{i + 1} , {Q}_{k}^{i + 1} , {U}^{i + 1} , {V}^{i + 1} ) - ℱ ( {X}_{{Ω}^{c} k}^{i} , {Y}_{k}^{i} , {Z}_{k}^{i} , {S}_{k}^{i} , {P}_{k}^{i} , {Q}_{k}^{i} , {U}^{i} , {V}^{i} ) \leq \frac{1}{ρ} {‖ {P}_{k}^{i + 1} - {P}_{k}^{i} ‖}_{F}^{2} + \frac{1}{ρ} {‖ {Q}_{k}^{i + 1} - {Q}_{k}^{i} ‖}_{F}^{2} - \frac{1 + ρ}{2} {‖ {Y}_{k}^{i + 1} - {Y}_{k}^{i} ‖}_{F}^{2} - \frac{ρ}{2} {‖ {Z}_{k}^{i + 1} - {Z}_{k}^{i} ‖}_{F}^{2}$$

By combining the equations 15 and (17), the following is obtained:

$$2 ( {Y}_{k}^{i + 1} - {X}_{Ω k} - {X}_{{Ω}^{c} k}^{i} ) + 2 λ {L}^{T} {LY}_{k}^{i + 1} + {P}_{k}^{i + 1} - {Q}_{k}^{i} - ρ ( {Z}_{k}^{i} - {Y}_{k}^{i + 1} ) = 0 \qquad ( 32 )$$

Similarly, by combining the equations (18) and (19), the following is obtained:

$$λ {Z}_{k}^{i + 1} {RR}^{T} + {Q}_{k}^{i + 1} = 0 \qquad ( 33 )$$

Based on the equation (32), it is further derived that:

$${‖ {P}_{k}^{i + 1} - {P}_{k}^{i} ‖}_{F}^{2} = ‖ ( 2 + ρ + 2 λ {L}^{T} L ) ( {Y}_{k}^{i} - {Y}_{k}^{i + 1} ) + ρ ( {Z}_{k}^{i} - {Z}_{k}^{i - 1} ) - \qquad ( 34 )$$

$${2 ( {X}_{{Ω}^{c} k}^{i - 1} - {X}_{{Ω}^{c} k}^{i} ) + {Q}_{k}^{i} - {Q}_{k}^{i - 1} ‖}_{F}^{2}$$

Substituting the equation (29) and the equation (16) into the equation (34) returns:

$${‖ {P}_{k}^{i + 1} - {P}_{k}^{i} ‖}_{F}^{2} = ‖ ( 2 + ρ + 2 λ {L}^{T} L ) ( {Y}_{k}^{i} - {Y}_{k}^{i + 1} ) + ρ ( {Z}_{k}^{i} - {Z}_{k}^{i - 1} ) - \qquad ( 35 )$$

$${2 ( {Y}_{k}^{i - 1} - {Y}_{k}^{i} ) + 2 λ ( {Z}_{k}^{i + 1} - {Z}_{k}^{i} ) {R}^{T} R ‖}_{F}^{2} \leq$$

$${\underbrace{4 {‖ ( 2 + ρ + 2 λ {L}^{T} L ) ( {Y}_{k}^{i + 1} - {Y}_{k}^{i} ) ‖}_{F}^{2}}}_{a} + {\underbrace{16 {λ}^{2} {‖ ( {Z}_{k}^{i + 1} - {Z}_{k}^{i} ) {RR}^{T} ‖}_{F}^{2}}}_{b} +$$

$${\underbrace{16 {‖ {Y}_{k}^{i} - {Y}_{k}^{i - 1} ‖}_{{Ω}^{c}}^{2}}}_{c} + 4 {ρ}^{2} {‖ {Z}_{k}^{i} - {Z}_{k}^{i - 1} ‖}_{F}^{2}$$

For term a, it is obtained that:

$$a \leq 4 {( 2 + ρ + 2 λ {λ}_{L} )}^{2} {‖ {Y}_{k}^{i + 1} - {Y}_{k}^{i} ‖}_{F}^{2} \qquad ( 36 )$$

where λ_{L} is the maximum eigenvalue of L^{T} L.

For term b, it is obtained that:

$$b \leq 16 {λ}^{2} {λ}_{R}^{2} {‖ {Z}_{k}^{i + 1} - {Z}_{k}^{i} ‖}_{F}^{2} \qquad ( 37 )$$

where λ_{R} is the maximum eigenvalue of RR^{T}.

For term c, it is obtained that:

$$c \leq 16 {‖ {Y}_{k}^{i} - {Y}_{k}^{i - 1} ‖}_{F}^{2} \qquad ( 38 )$$

By employing the equations (36), (37) and (38), the equation (34) is rewritten as:

$$( 39 )$$

$${‖ {P}_{k}^{i + 1} - {P}_{k}^{i} ‖}_{F}^{2} \leq \text{} 4 {( 2 + ρ + 2 λ {λ}_{L} )}^{2} {‖ {Y}_{k}^{i + 1} - {Y}_{k}^{i} ‖}_{F}^{2} + 16 {‖ {Y}_{k}^{i} - {Y}_{k}^{i - 1} ‖}_{F}^{2} + 16 {λ}^{2} {λ}_{R}^{2} {‖ {Z}_{k}^{i + 1} - {Z}_{k}^{i} ‖}_{F}^{2}$$

Similarly, with the use of the equation (33), the following equation is obtained:

$${‖ {Q}_{k}^{i + 1} - {Q}_{k}^{i} ‖}_{F}^{2} \leq 4 {λ}^{2} {λ}_{R}^{2} {‖ {Z}_{k}^{i + 1} - {Z}_{k}^{i} ‖}_{F}^{2} \qquad ( 40 )$$

By combining the equations (39), (40), and (31), the following is obtained:

$$( 41 )$$

$$ℱ ( {X}_{{Ω}^{c} k}^{i + 1} , {Y}_{k}^{i + 1} , {Z}_{k}^{i + 1} , {S}_{k}^{i + 1} , {P}_{k}^{i + 1} , {Q}_{k}^{i + 1} , {U}^{i + 1} , {V}^{i + 1} ) - ℱ ( {X}_{{Ω}^{c} k}^{i} , {Y}_{k}^{i} , {Z}_{k}^{i} , {S}_{k}^{i} , {P}_{k}^{i} , {Q}_{k}^{i} , {U}^{i} , {V}^{i} ) \leq [ \frac{4}{ρ} {( 2 + ρ + 2 λ {λ}_{L} )}^{2} - \frac{1 + ρ}{2} ] {‖ {Y}_{k}^{i + 1} - {Y}_{k}^{i} ‖}_{F}^{2} + [ \frac{20}{ρ} {λ}^{2} {λ}_{R}^{2} - \frac{ρ}{2} ] {‖ {Z}_{k}^{i + 1} - {Z}_{k}^{i} ‖}_{F}^{2} + \frac{16}{ρ} {‖ {Y}_{k}^{i} - {Y}_{k}^{i - 1} ‖}_{F}^{2} + 4 ρ {‖ {Z}_{k}^{i} - {Z}_{k}^{i - 1} ‖}_{F}^{2}$$

Then, according to the equation (22), it is held that:

$$( 42 )$$

$$\tilde{ℱ} ( {Φ}^{i + 1} , {Y}_{k}^{i} , {Z}_{k}^{i} ) - \tilde{ℱ} ( {Φ}^{i} , {Y}_{k}^{i - 1} , {Z}_{k}^{i - 1} ) \leq - \{ \frac{4}{ρ} [ {( 2 + ρ + 2 λ {λ}_{L} )}^{2} + 4 ] - \frac{1 + ρ}{2} \} {‖ {Y}_{k}^{i + 1} - {Y}_{k}^{i} ‖}_{F}^{2} - [ \text{} \frac{20}{ρ} {λ}^{2} {λ}_{R}^{2} + \frac{7 ρ}{2} ] {‖ {Z}_{k}^{i + 1} - {Z}_{k}^{i} ‖}_{F}^{2} < 0$$

It is then established that [symbol] (Φⁱ, \tilde{Y}, \tilde{Z}) is monotonically non-increasing.

### Q.E.D.

Based on Lemma 1, it is concluded that if p₁<0 and p₂<0, the auxiliary function [symbol] (Φⁱ, \tilde{Y}, \tilde{Z}) is monotonically non-increasing, and it is further inferred that the function is convergent since it is bounded below by 0.

Given Lemma 1, the following lemmas are obtained.

Lemma 2: The sequence {Φⁱ} generated by Algorithm 1 is bounded and satisfies:

$${lim}_{i \to ∞} {‖ {Φ}^{i + 1} - {Φ}^{i} ‖}_{F}^{2} = 0 \qquad ( 43 )$$

Given that

$${Y}_{k}^{0} < ∞ and {Z}_{k}^{0} < ∞ ,$$

and Lemma 1 that [symbol] is bounded, it is concluded that sequences

$${\{ {Y}_{k}^{i} \}}_{i = 1}^{I} and {\{ {Z}_{k}^{i} \}}_{i = 1}^{I}$$

must be bounded.

Furthermore, since

$${X}_{{Ω}^{c} k}^{i}$$

is a subset of Yₖⁱ (see the equation (16)), it can be inferred that sequence

$${\{ {X}_{{Ω}^{c} k}^{i} \}}_{i = 1}^{I}$$

is bounded. Based on this, according to the equation (15) and the equation (17), it is deduced that the sequence

$${\{ {P}_{k}^{i} \}}_{i = 1}^{I}$$

is bounded because:

$${P}_{k}^{i} = 2 ( {X}_{Ω k} + {X}_{{Ω}^{c} k}^{i - 1} ) - ( 2 + ρ + 2 λ {L}^{T} L ) {Y}_{k}^{i} - 2 λ {Z}_{k}^{i - 1} R {R}^{T} + ρ {Z}_{k}^{i - 1} \qquad ( 44 )$$

According to the equation (18) and the equation (19), it is obtained:

$${Q}_{k}^{i} = 2 λ {Z}_{k}^{i} R {R}^{T} \qquad ( 45 )$$

which indicates that the sequence

$${\{ {Q}_{k}^{i} \}}_{i = 1}^{I}$$

is also bounded.

As a result, the sequence

$${\{ {Φ}^{i} \}}_{i = 1}^{I}$$

is bounded.

Additionally, if all inequalities in the equation (23) are summed from i=1 to I−1, the following inequality is obtained:

$${\sum }_{i = 1}^{I} - {p}_{1} {‖ {Y}_{k}^{i + 1} - {Y}_{k}^{i} ‖}_{F}^{2} - {p}_{2} {‖ {Z}_{k}^{i + 1} - {Z}_{k}^{i} ‖}_{F}^{2} \leq \tilde{ℱ} ( {Φ}^{1} , {Y}_{k}^{0} , {Z}_{k}^{0} ) - \tilde{ℱ} ( {Φ}^{I + 1} , {Y}_{k}^{I} , {Z}_{k}^{I} ) < ∞ \qquad ( 46 )$$

When I→∞, the following is obtained:

$${lim}_{I \to ∞} {\sum }_{i = 1}^{I} - {p}_{1} {‖ {Y}_{k}^{i + 1} - {Y}_{k}^{i} ‖}_{F}^{2} - {p}_{2} {‖ {Z}_{k}^{i + 1} - {z}_{k}^{i} ‖}_{F}^{2} \leq {lim}_{I \to ∞} \tilde{ℱ} ( {Φ}^{1} , {Y}_{k}^{0} , {Z}_{k}^{0} ) - \tilde{ℱ} ( {Φ}^{l + 1} , {Y}_{k}^{I} , {Z}_{k}^{I} ) < ∞ \qquad ( 47 )$$

Since [symbol] (Φⁱ, \tilde{Y}, \tilde{Z}) is lower-bounded and non-increasing, the following is obtained:

$${lim}_{i \to ∞} {‖ {Y}_{k}^{i + 1} - {Y}_{k}^{i} ‖}_{F}^{2} = 0 \qquad ( 48 )$$

$${lim}_{i \to ∞} {‖ {Z}_{k}^{i + 1} - {Z}_{k}^{i} ‖}_{F}^{2} = 0 \qquad ( 49 )$$

The same results are applicable to all other variables, which indicates that:

$${lim}_{i \to ∞} {‖ {Φ}^{i + 1} - {Φ}^{i} ‖}_{F}^{2} = 0 \qquad ( 50 )$$

### Q.E.D.

Lemma 3: Let {Φⁱ^{ⱼ}} be a subsequence of {Φⁱ} such that limᵢ_{ⱼ}_{→∞}Φⁱ^{ⱼ}=Φ*. Then, Φ* is a a stationary point of the equation (11).

Proof: Since

$${\{ {Y}_{k}^{i} \}}_{i = 1}^{I}$$

is bounded, there exists a subsequence {Yⁱ^{ⱼ}} that converges to an accumulation point

$${Y}_{k}^{*} ,$$

i.e.,

$${lim}_{{k}_{{j}^{\to ∞}}} {Y}_{k}^{{k}_{j}} = {Y}_{k}^{*} .$$

The same results are applicable to U, Sₖ, V, Xₖ, Zₖ, and it is obtained that:

$${lim}_{{k}_{j} \to ∞} {U}^{{k}_{j}} = {U}^{*} ,$$

$${lim}_{{k}_{j} \to ∞} {S}_{k}^{{k}_{j}} = {S}_{k}^{*} , {lim}_{{k}_{j} \to ∞} {V}^{{k}_{j}} = {V}^{*} , {lim}_{{k}_{j} \to ∞} {X}_{k}^{{k}_{j}} = {X}_{k}^{*} , {lim}_{{k}_{j} \to ∞} {Z}_{k}^{{k}_{j}} = {Z}_{k}^{*} .$$

Since

$${Y}_{k}^{i + 1}$$

is the optimal solution to the equation (11), the following equation holds:

$$0 = \frac{\partial ℱ ( {X}_{{Ω}^{c} k}^{i} , {Y}_{k} , {Z}_{k}^{i} , {S}_{k}^{i + 1} , {P}_{k}^{i} , {Q}_{k}^{i} , {U}^{i + 1} , {V}^{i + 1} )}{\partial {Y}_{k}} {\vert}_{{Y}_{k} = {Y}_{k}^{i + 1}} = 2 ( {Y}_{k}^{i + 1} - {X}_{Ω k} + {X}_{{Ω}^{c} k}^{i} ) + 2 λ {L}^{T} {LY}_{k}^{i + 1} + {P}_{k}^{i} - {Q}_{k}^{i} + ρ ( {Y}_{k}^{i + 1} - {U}^{i + 1} {S}_{k}^{i + 1} {V}^{i + 1 T} ) - ρ ( {Z}_{k}^{i} - {Y}_{k}^{i + 1} ) \qquad ( 51 )$$

For simplicity, the following notation is used:

$${\partial }_{{Y}_{k}} ℱ ( {Φ}^{i + 1} ) = \frac{\partial ℱ ( {X}_{{Ω}^{c} k}^{i + 1} , {Y}_{k} , {Z}_{k}^{i + 1} , {S}_{k}^{i + 1} , {P}_{k}^{i + 1} , {Q}_{k}^{i + 1} , {U}^{i + 1} , {V}^{i + 1} )}{\partial {Y}_{k}} {\vert}_{{Y}_{k} = {Y}_{k}^{i + 1}}$$

Then, it follows that:

$${\partial }_{{Y}_{k}} ℱ ( {Φ}^{i + 1} ) = {\partial }_{{Y}_{k}} ℱ ( {X}_{{Ω}^{c} k}^{i + 1} , {Y}_{k}^{i + 1} , {Z}_{k}^{i + 1} , {S}_{k}^{i + 1} , {P}_{k}^{i + 1} , {Q}_{k}^{i + 1} , {U}^{i + 1} , {V}^{i + 1} ) - {\partial }_{{Y}_{k}} ℱ ( {X}_{{Ω}^{c} k}^{i} , {Y}_{k}^{i + 1} , {Z}_{k}^{i} , {S}_{k}^{i + 1} , {P}_{k}^{i} , {Q}_{k}^{i} , {U}^{i + 1} , {V}^{i + 1} ) = 2 ( {Y}_{k}^{i + 1} - {X}_{Ω k} + {X}_{{Ω}^{c} k}^{i + 1} ) + 2 λ {L}^{T} {LY}_{k}^{i + 1} + {P}_{k}^{i + 1} - {Q}_{k}^{i + 1} + ρ ( {Y}_{k}^{i + 1} - {U}^{i + 1} {S}_{k}^{i + 1} {V}^{i + 1 T} ) - ρ ( {Z}_{k}^{i + 1} - {Y}_{k}^{i + 1} ) - 2 ( {Y}_{k}^{i + 1} - {X}_{Ω k} + {X}_{{Ω}^{c} k}^{i} ) - 2 λ {L}^{T} {LY}_{k}^{i + 1} - {P}_{k}^{i} + {Q}_{k}^{i} - ρ ( {Y}_{k}^{i + 1} - {U}^{i + 1} {S}_{k}^{i + 1} {V}^{i + 1 T} ) + ρ ( {Z}_{k}^{i} - {Y}_{k}^{i + 1} ) = 2 ( {X}_{{Ω}^{c} k}^{i + 1} - {X}_{{Ω}^{c} k}^{i} ) - ρ ( {Z}_{k}^{i + 1} - {Z}_{k}^{i} ) + {P}_{k}^{i + 1} - {P}_{k}^{i} - ( {Q}_{k}^{i + 1} - {Q}_{k}^{i} ) \qquad ( 52 )$$

Hence, according to the equation (50), when iⱼ→∞, it is obtained that: limᵢ_{ⱼ}_{→∞}∂_{Y}_{ₖ} [symbol] (Φⁱ^{ⱼ}⁺¹)=0.

A similar operation is applied to

$${Z}_{k}^{i + 1} ,$$

which is the optimal solution to the equation (18). Then, it is known that:

$$0 = {\partial }_{{Z}_{k}} ℱ ( {X}_{{Ω}^{c} k}^{i + 1} , {Y}_{k}^{i + 1} , {Z}_{k}^{i + 1} , {S}_{k}^{i + 1} , {P}_{k}^{i + 1} , {Q}_{k}^{i} , {U}^{i + 1} , {V}^{i + 1} ) = 2 λ {Z}_{k}^{i + 1} R {R}^{T} + {Q}_{k}^{i} + ρ ( {Z}_{k}^{i + 1} - {Y}_{k}^{i + 1} ) \qquad ( 53 )$$

It is defined that:

$${\partial }_{{Z}_{k}} ℱ ( {Φ}^{i + 1} ) = {\partial }_{{Z}_{k}} ℱ ( {X}_{{Ω}^{c} k}^{i + 1} , {Y}_{k}^{i + 1} , {Z}_{k}^{i + 1} , {S}_{k}^{i + 1} , {P}_{k}^{i + 1} , {Q}_{k}^{i + 1} , {U}^{i + 1} , {V}^{i + 1} ) - {\partial }_{{Z}_{k}} ℱ ( {X}_{{Ω}^{c} k}^{i + 1} , {Y}_{k}^{i + 1} , {Z}_{k}^{i + 1} , {S}_{k}^{i + 1} , {P}_{k}^{i + 1} , {Q}_{k}^{i} , {U}^{i + 1} , {V}^{i + 1} ) = {Q}_{k}^{i + 1} - {Q}_{k}^{i} \qquad ( 54 )$$

Thus, when iⱼ→∞, it is obtained that: limᵢ_{ⱼ}_{→∞}∂_{Z}_{ₖ} [symbol] (Φⁱ^{ⱼ}⁺¹)=0.

Similarly, for

$${U}^{{i}_{j}} , {S}_{k}^{{i}_{j}} , {V}^{{i}_{j}} , {X}_{{Ω}^{c} k}^{{i}_{j}} ,$$

the following are obtained:

$$0 = {lim}_{{i}_{j} \to ∞} {\partial }_{{U}_{k}} ℱ ( {Φ}^{{i}_{j} + 1} ) \qquad ( 55 )$$

$$0 = {lim}_{{i}_{j} \to ∞} {\partial }_{{S}_{k}} ℱ ( {Φ}^{{i}_{j} + 1} ) \qquad ( 56 )$$

$$0 = {lim}_{{i}_{j} \to ∞} {\partial }_{{V}_{k}} ℱ ( {Φ}^{{i}_{j} + 1} ) \qquad ( 57 )$$

$$0 = {lim}_{{i}_{j} \to ∞} {\partial }_{{X}_{Ω} {c}_{k}} ℱ ( {Φ}^{{i}_{j} + 1} ) \qquad ( 58 )$$

In addition, via the equation (51) and by taking the limit of the equation (17) as iⱼ→∞, it is obtained that:

$${P}_{k}^{*} = 2 ( {X}_{Ω k} + {X}_{{Ω}^{c} k}^{*} ) - ( 2 + ρ + 2 λ {L}^{T} L ) {Y}_{k}^{*} + {Z}_{k}^{*} ( ρ - 2 λ R {R}^{T} ) \qquad ( 59 )$$

Likewise, by the equation employing (53) and the equation (19), the following is obtained:

$${Q}_{k}^{*} = 2 λ {Z}_{k}^{*} R {R}^{T} \qquad ( 60 )$$

In summary, the accumulation point Φ* is shown to be a stationary point of the augmented Lagrangian [symbol] . Q.E.D.

### D. Time Complexity Analysis

The time complexity of MMC is dominated by the updates of

$$U , V , {\{ {Y}_{k} \}}_{k = 1}^{K} , {\{ {Z}_{k} \}}_{k = 1}^{K} .$$

In the i th iteration, Uⁱ⁺¹ and Vⁱ⁺¹ are obtained by GLRAM. The calculation of Uⁱ⁺¹ and Vⁱ⁺¹ involves a complexity of [symbol] (I_{G}K (m+n)² max(r,c)), where I_{G} is the number of loops in GLRAM. The cost of Yₖ is [symbol] (2m³+m²n), hence K sub-problems together are [symbol] (K[2m³+m²n]). Similarly, the complexity of [symbol] (K[2n³+mn²]) is obtained as

$${\{ {Z}_{k} \}}_{k = 1}^{K} .$$

With the assumption of Iₘ iterations, the total complexity of MMC is determined as:

$$𝒪 ( {I}_{m} {I}_{G} {K ( m + n )}^{2} max ( r , c ) + {I}_{m} K [ 2 {m}^{3} + 2 {n}^{3} + m n ( m + n ) ] )$$

### E. Experimental Results

In this section, image inpainting is first evaluated, followed by video restoration. Four categories, with a total of five methods, are involved in the comparative study: matrix rank minimization based: SVP; matrix factorization based: [symbol] ₂-reg, LMaFit; tensor tubal rank minimization based: t-SVD; tensor factorization based: TCTF. In the provided experiments, the recommended setting of parameters for the competing algorithms is adopted. If suggested parameters are not available, the parameters are selected as the values which possess the best performance among numerous trials. For the metrics, peak signal-to-noise ratio (PSNR) and structural similarity index measure (SSIM) evaluate the objective and subjective recovery accuracy, respectively. The larger the PSNR value and the closer the SSIM value is to 1, the better the recovery quality. Two missing patterns are considered, including: Pattern I: Random missingness; and Pattern II: Combination of random and structural missingness.

### E.1 Image Inpainting

### Single Image Inpainting

MMC is capable of restoring single grayscale image as well as single color image. Three hyper-parameters need to be set in MMC, dimension of the transformed space d, the smoothing-control parameter λ, and the augmented Lagrangian parameter ρ. It is set that d=300, λ=0.1 and ρ=1 for missing data pattern I, and d=300, λ=0.2 and ρ=1 for missing data pattern II. For MC-based baselines [symbol] ₂-reg, LMaFit and SVP, the rank parameter is set to 20.

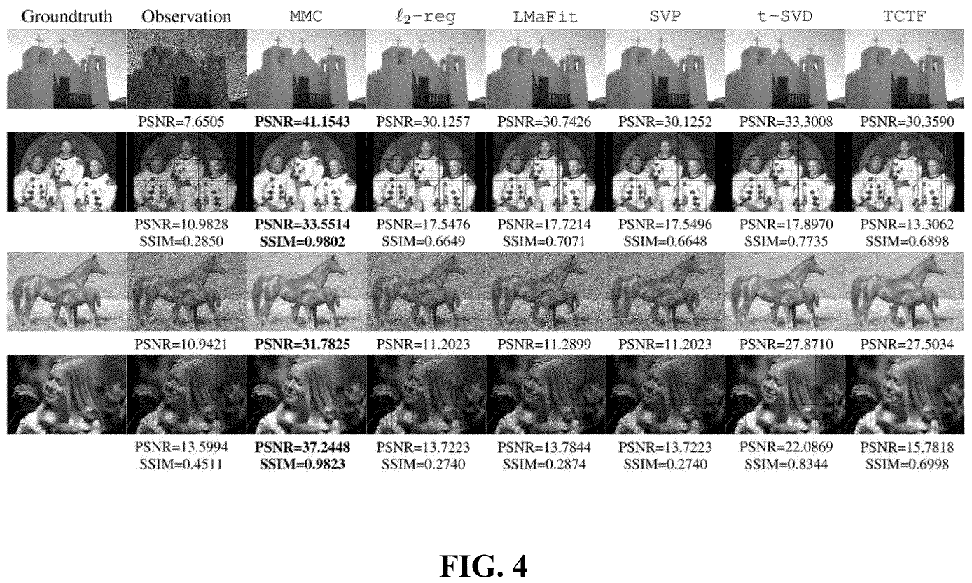

FIG. 4 shows different images with missing data patterns I and II.

Herein, two images are shown in the first and second rows of FIG. 4. It is seen that when only random missingness is present, MMC has the highest PSNR and best visual quality. PSNRs of the remaining baselines are comparable, whereas results of the three MC-based methods are slightly vague. When structural missingness occurs, all approaches except MMC only recover randomly missing elements, but are powerless against structurally missing ones, and as a result the corresponding PSNRs deteriorate significantly. While MMC successfully reconstructs all the missing entries and yields the highest PSNR and SSIM, we attribute this to the Tikhonov regularization in our framework.

Herein, two images are shown in the third and fourth rows of FIG. 4. In the restoration processing described herein, the images are processed as color image data, while, for clarity of illustration, the corresponding images in FIG. 4 are presented in grayscale. It is observed that for image restoration (i.e., color image restoration), the performance basically resembles that of grayscale ones. For both missing patterns, although slightly improvement can be found in PSNRs of [symbol] ₂-reg, LMaFit and SVP, their results exhibit severe ambiguity. t-SVD and TCTF perform well when dealing with random missing data, achieving results similar to MMC, but their performance degrades in the presence of structural missingness. MMC achieves the highest PSNR, which is the only one exhibiting clear reconstruction without any structurally missing remnants. This superior performance is due to MMC's ability to effectively leverage the correlation among rows/columns.

### Multiple Image Inpainting

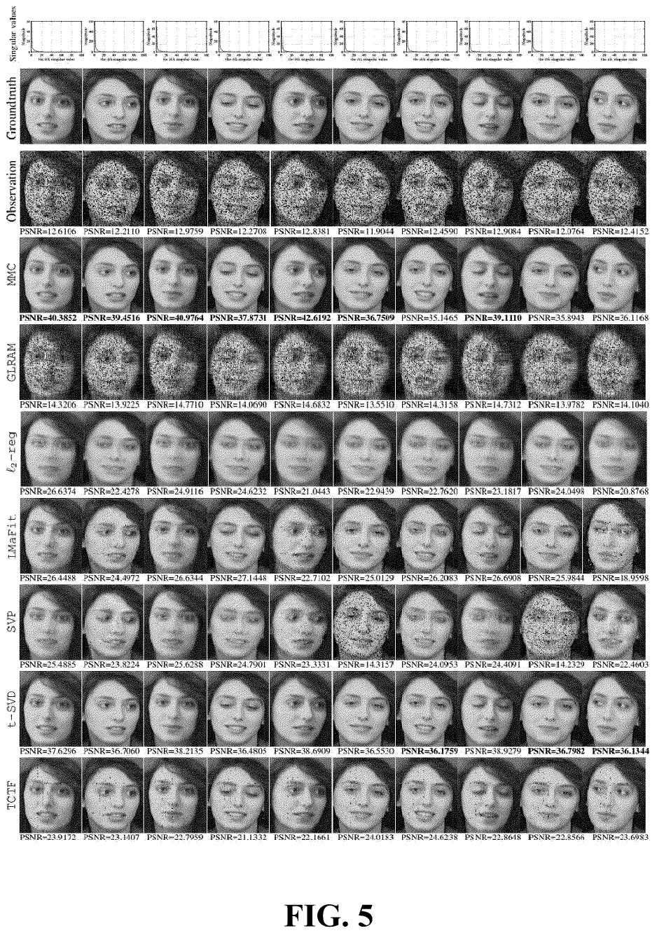

Firstly, 10 facial images are recovered with randomly missing entries. FIG. 5 displays 10 original images, singular values of each image, observations, and recovery results by each algorithm. Especially, GLRAM is introduced as a baseline in this experiment, whose parameter d is set to 90. It is noticed that the results of [symbol] ₂-reg and SVP are very blurry, there even exist overlapping between the images. Although LMaFit and TCTF do not exhibit such a phenomenon, there are still missing elements remaining and the PSNRs are still relatively low. t-SVD demonstrates rather good performance, but MMC is still better. Aside from fully utilizing inter-matrix and inner-matrix information, this is attributed to MMC's stronger robustness to non-smooth data.

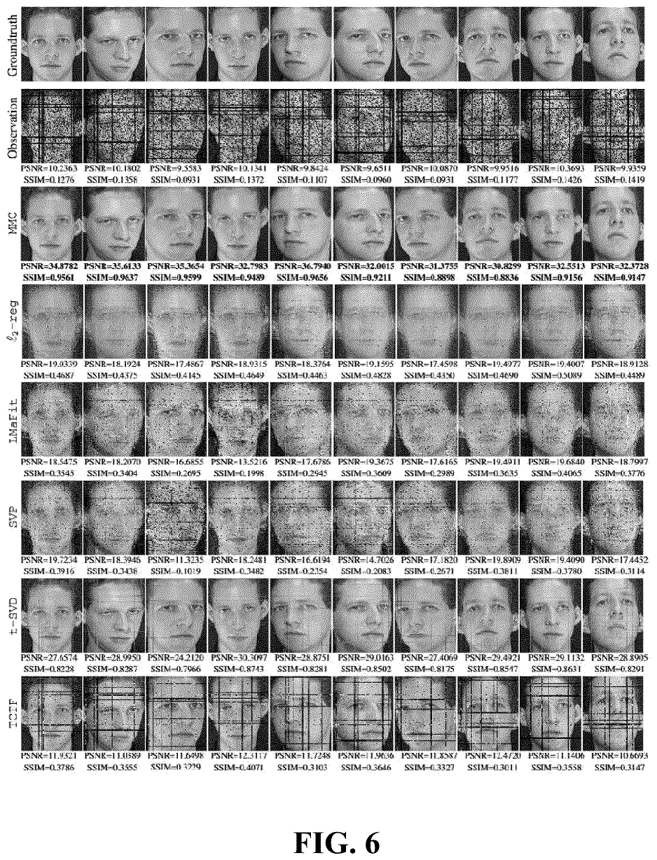

Next, multiple image inpainting with random and structural missingness is studied. As shown in FIG. 6, it is observed that the advantage of MMC is substantial, achieving the highest PSNR and SSIM, while other methods exhibit blurring artifacts.

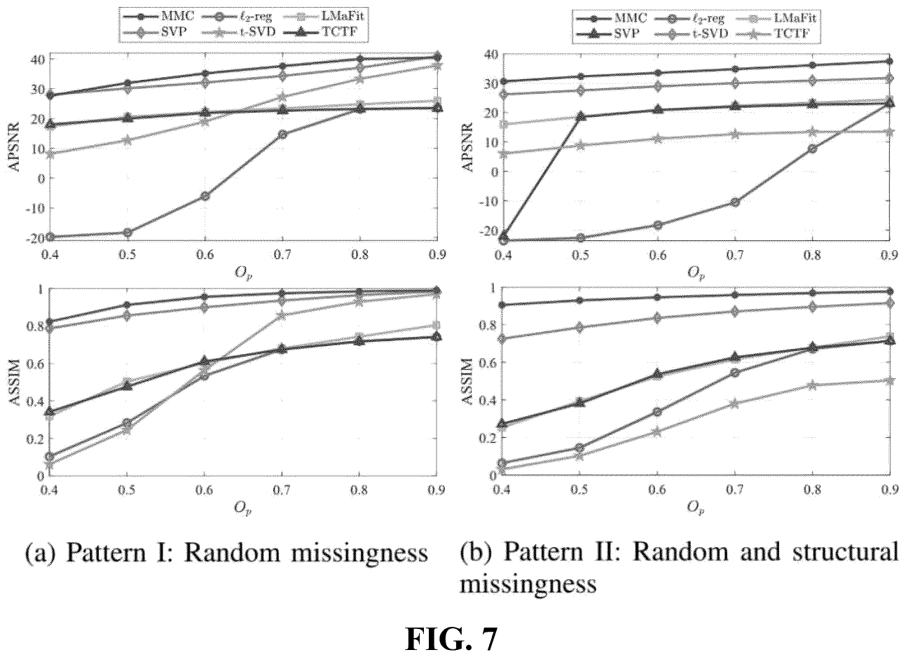

The effect of observation percentage Oₚ is further studied on the APSNR and ASSIM, where APSNR calculates the average PSNR of multiple images. The same idea leads to ASSIM. FIG. 7 shows PSNR and SSIM versus observation percentage Oₚ according to some embodiments of the present invention, containing part (a) and part (b).

In FIG. 7, part (a) depicts APSNR and ASSIM versus Oₚ with random missingness averaged over 100 trials, from which we observe that as Oₚ grows from 0.4 to 0.9, APSNR and ASSIM increase for all algorithms. MMC consistently possesses the highest APSNR and ASSIM as Oₚ varies from 0.4 to 0.9, indicating that our framework can achieve good performance even with a limited number of observations.

In FIG. 7, part (b) plots the APSNR and ASSIM versus Oₚ∈[0.4,0.9] with random and structural incompleteness. It is seen that [symbol] ₂-reg becomes highly ineffective, LMaFit and SVP remain similar for Oₚ>0.5, and TCTF also shows degradation. MMC significantly outperforms t-SVD by about 3 dB in terms of APSNR across all Oₚs.

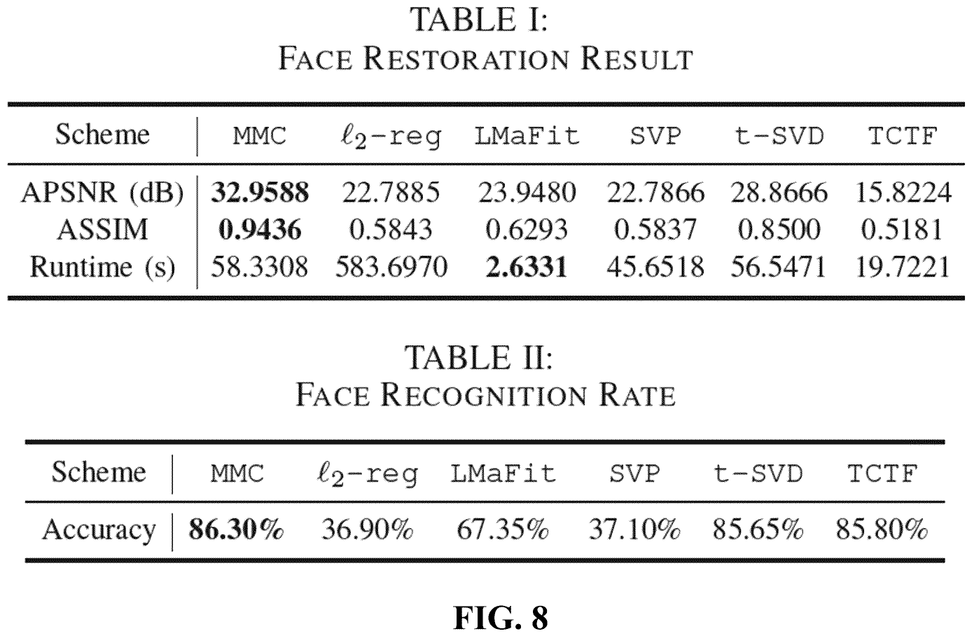

The face restoration results are listed in Table I in FIG. 8, including APSNR, ASSIM and average runtime for 400 images recovered by each algorithm, averaged over 20 trials. It is noted that the MMC outperforms the remaining algorithms in terms of APSNR and ASSIM while maintaining a comparable overhead to t-SVD. Among the methods evaluated, LMaFit exhibits the fastest speed yet low accuracy; t-SVD demonstrates the same computational pace as ours but a worse recovery performance; despite running quickly, TCTF yields the lowest APSNR and ASSIM. The three MC-based methods share similar accuracy, among them, [symbol] ₂-reg is prohibitively inefficient.

Subsequently, these recovery results are input into Eigenface to compute the face recognition rates, which are presented in Table II in FIG. 8. MMC achieves the highest recognition rate, reaching 86.30%. This experiment demonstrates the effectiveness of the proposed method in handling multiple, non-smooth image data with structurally missing entries all together.

### E.2 Video Restoration

A grayscale video can be regarded as a third-order tensor, with high correlation between frames. This makes video restoration a suitable application for MMC. The combination of random and structural missingness is studied. The optimal hyper-parameters of MMC are d=400, λ=0.3 and ρ=1.

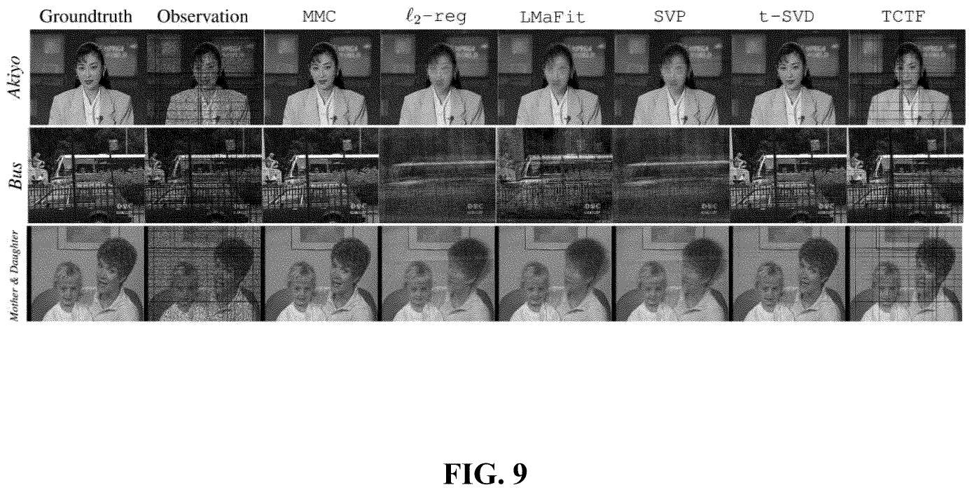

FIG. 9 shows the ground truth, observation and algorithm outputs using the 10th frame of each video. The recovered results by [symbol] ₂-reg, LMaFit and SVP are fuzzy; t-SVD and TCTF leave missing lines incomplete. Meanwhile, the proposed scheme does not exhibit such artifacts thanks to the effective utilization of the inter-matrix and inner-matrix correlations.

The advantages of the present invention over existing technologies and works include:

The solution provided by the present invention achieves overwhelming superiority in restoring structurally incomplete matrices, over the state-of-the-art techniques, including SVP, [symbol] ₂-reg, LMaFit, t-SVD and TCTF.

The solution provided by the present invention demonstrates outstanding performance in restoring randomly incomplete matrices, compared to the state-of-the-art techniques, including SVP, [symbol] ₂-reg, LMaFit, t-SVD and TCTF.

The solution provided by the present invention performs better in simultaneously recovering multiple matrices than conventional matrix completion methods such as SVP, [symbol] ₂-reg and LMaFit.

The solution provided by the present invention is superior in recovering non-smooth data (data with non-smooth change along the frames), compared to Fourier transform based tensor completion methods such as t-SVD and TCTF.

The solution provided by the present invention does not necessitate a dictionary pre-trained on extra datasets, different from ReLaSP and TranSpa.

### Physical Device Implementation

The data recovery framework disclosed herein is suitable for physical implementation on hardware platforms such as field programmable gate arrays (FPGA), application specific integrated circuits (ASIC), and other computing devices. In such implementations, the disclosed operations are executed by physical processing units in cooperation with memory resources and control logic to perform multi-matrix data recovery on stored data, rather than as an abstract mathematical process. Accordingly, the disclosed system receives real-world data as input, performs structured data recovery through hardware-executed processing operations, and outputs recovered matrix data in a tangible form for further use.

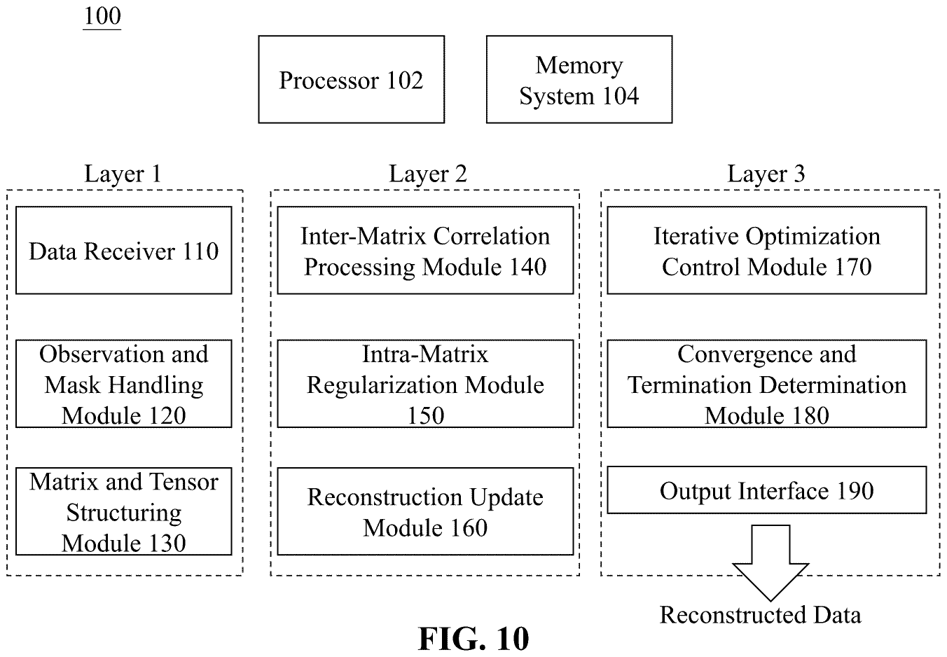

FIG. 10 illustrates a block diagram for an architecture of a structural data recovery processing system 100 for performing structural data recovery on partially observed matrix-based data using a multi-matrix processing framework according to some embodiments of the present invention.

The structural data recovery processing system 100 is configured to process incomplete matrix-based data sets and to restore structurally missing data elements through coordinated multi-matrix processing operations. The structural data recovery processing system 100 is further configured to receive real-world data sets containing missing data entries, to perform structured data recovery operations through execution by physical processing resources, and to output recovered matrix data in a tangible form suitable for subsequent storage, display, transmission, or further processing. In operation, the structural data recovery processing system 100 is capable of executing data recovery tasks including image inpainting, video restoration, sensor data reconstruction, and other matrix-based data recovery operations involving structurally missing data elements.

Specifically, the structural data recovery processing system 100 includes a processor 102, a memory module 104, and a plurality of functional modules. The plurality of functional modules include a data receiver 110, an observation and mask handling module 120, a matrix and tensor structuring module 130, an inter-matrix correlation processing module 140, an intra-matrix regularization module 150, a reconstruction update module 160, an iterative optimization control module 170, a convergence and termination determination module 180, and an output interface 190.

The processor 102, the memory module 104, and the plurality of functional modules of the structural data recovery processing system 100 are communicatively coupled to one another via one or more communication paths. Such communication paths may include wired connections, wireless connections, or a combination thereof, and may support unidirectional or bidirectional data exchange between the respective components.

Through coordinated operation of the processor 102, the memory module 104, and the plurality of functional modules, the structural data recovery processing system 100 is configured to perform practical data processing tasks on incomplete matrix-based data. In operation, the structural data recovery processing system 100 receives input data sets containing missing data entries, executes structured data recovery operations using physical processing resources, and produces reconstructed data outputs in a tangible form suitable for storage, display, transmission, or further processing. In practical implementations, the reconstructed data outputs produced by the structural data recovery processing system 100 may include reconstructed digital images, restored image frames of a video sequence, completed sensor measurement matrices, reconstructed radio environment maps, or recovered numerical data sets representing physical or measured phenomena.

Compared to conventional data recovery approaches that primarily rely on independently processing single data sets or assume randomly missing data entries, the coordinated processing performed by the structural data recovery processing system 100 enables effective handling of data sets containing structurally missing rows or columns by leveraging correlations across multiple data instances within a unified processing architecture.

The processor 102 is configured to coordinate operation of the structural data recovery processing system 100 by controlling execution of the plurality of functional modules and managing data flow therebetween. The processor 102 executes control instructions stored in the memory module 104 to schedule processing operations, manage iterative execution of data recovery tasks, and coordinate access to shared system resources during operation of the structural data recovery processing system 100.

The memory module 104 is configured to store program instructions, configuration parameters, input data sets received by the structural data recovery processing system 100, intermediate data generated during processing, and reconstructed data outputs produced by the structural data recovery processing system 100. The memory module 104 may include one or more types of non-transitory storage media and is accessible by the processor 102 and the plurality of functional modules to support coordinated execution of structural data recovery operations.

For purposes of structural organization and physical implementation, the structural data recovery processing system 100 arranges the plurality of functional modules into multiple functional layers. The layered architecture is configured to separate data input and preparation, core data recovery processing, and control and output operations, thereby facilitating coordinated execution of practical data processing tasks using physical processing resources and avoiding treatment of the disclosed system as an abstract computational concept.

In the layered architecture, a first functional layer is configured to handle reception, identification, and structural organization of input data sets containing missing data entries. A second functional layer is configured to perform core data recovery processing operations on the organized data by exploiting correlations across and within multiple data instances. A third functional layer is configured to manage execution control, iteration coordination, termination determination, and output of reconstructed data produced by the structural data recovery processing system 100.

The first functional layer of the structural data recovery processing system 100 includes the data receiver 110, the observation and mask handling module 120, and the matrix and tensor structuring module 130. The modules of the first functional layer are communicatively coupled to one another and are configured to cooperatively prepare input data sets for subsequent data recovery processing performed by the structural data recovery processing system 100.

The data receiver 110 is configured to serve as an operable interface of the structural data recovery processing system 100 for receiving input data sets containing incomplete matrix-based data from one or more external sources. In addition to receiving data, the data receiver 110 is configured to provide an interface through which a user or an external system may initiate data recovery tasks, select or specify input data sets, and provide operation-related inputs to the structural data recovery processing system 100. The input data sets received by the data receiver 110 may include, for example, digital images, image sequences, sensor measurement matrices, or other matrix-based data associated with real-world measurements. The data receiver 110 outputs the received incomplete data sets, together with any associated operation-related information, to the observation and mask handling module 120 for further processing.

The observation and mask handling module 120 is communicatively coupled to the data receiver 110 and is configured to identify observed data entries and missing data entries within the received data sets. In particular, the observation and mask handling module 120 generates observation information indicating locations of missing data entries, including locations corresponding to structurally missing rows and/or columns. The observation information and the corresponding incomplete data sets are provided as output to the matrix and tensor structuring module 130.

The matrix and tensor structuring module 130 is communicatively coupled to the observation and mask handling module 120 and is configured to organize the incomplete data sets and the observation information into a structured multi-matrix or tensor-like representation suitable for joint processing by the structural data recovery processing system 100. The structured representation generated by the matrix and tensor structuring module 130 is provided as input to one or more functional modules of the second functional layer for execution of core data recovery processing operations.

The second functional layer of the structural data recovery processing system 100 includes the inter-matrix correlation processing module 140, the intra-matrix regularization module 150, and the reconstruction update module 160. The modules of the second functional layer are communicatively coupled to one another and are configured to cooperatively perform core data recovery processing on structured data prepared by the first functional layer, thereby enabling restoration of structurally missing data elements.

The inter-matrix correlation processing module 140 is a core functional module of the structural data recovery processing system 100 and is configured to extract and utilize correlations across multiple matrix-based data instances. The inter-matrix correlation processing module 140 is communicatively coupled to the matrix and tensor structuring module 130 and is configured to receive the structured multi-matrix or tensor-like representation generated by the first functional layer.

Upon receiving the structured representation, the inter-matrix correlation processing module 140 processes multiple incomplete matrices jointly, rather than independently, to identify shared structural characteristics among the matrices. Such shared structural characteristics represent correlations that are common across different data instances and are indicative of underlying relationships among the matrices beyond information available within any single matrix alone.

In particular, the inter-matrix correlation processing module 140 is configured to generate an inter-matrix correlation representation that captures common patterns, shared components, or correlated substructures across the plurality of matrices. The inter-matrix correlation representation provides a mechanism through which information from one matrix may contribute to recovery of missing data entries in another matrix, thereby mitigating limitations associated with processing each matrix in isolation.

The inter-matrix correlation processing module 140 is especially advantageous in scenarios involving structural missingness, such as cases where entire rows or columns are missing from one or more matrices. In such scenarios, information contained within a single incomplete matrix may be insufficient to support reliable recovery. By leveraging correlations derived from other matrices that retain corresponding structural information, the inter-matrix correlation processing module 140 enables compensation for information loss associated with structurally missing data regions.

In operation, the inter-matrix correlation processing module 140 generates inter-matrix correlation outputs based on joint analysis of the structured data received from the matrix and tensor structuring module 130. The inter-matrix correlation outputs characterize relationships among the matrices and provide correlation constraints or guidance that may be used during reconstruction of missing data entries. The inter-matrix correlation outputs are provided to the reconstruction update module 160 as input for updating reconstructed matrix data.

The inter-matrix correlation processing module 140 may further be configured to update the inter-matrix correlation representation iteratively based on intermediate reconstruction results generated by the reconstruction update module 160. In such configurations, the inter-matrix correlation processing module 140 cooperates with the reconstruction update module 160 to refine extracted correlations as reconstruction progresses, thereby enabling adaptive utilization of cross-matrix information during the data recovery process.

By explicitly incorporating inter-matrix correlations into the data recovery pipeline, the inter-matrix correlation processing module 140 provides a technical improvement over conventional data recovery approaches that rely primarily on correlations within individual matrices or assume randomly distributed missing data entries. The coordinated use of cross-matrix correlation information enables the structural data recovery processing system 100 to effectively address data recovery tasks involving structurally missing rows or columns that cannot be reliably handled by single-matrix processing techniques.

The intra-matrix regularization module 150 is a core functional module of the structural data recovery processing system 100 and is configured to exploit structural correlations within individual matrix-based data instances. The intra-matrix regularization module 150 is communicatively coupled to the matrix and tensor structuring module 130 and is configured to receive structured data corresponding to individual matrices generated by the first functional layer.

Upon receiving the structured data, the intra-matrix regularization module 150 processes each matrix to characterize internal structural relationships associated with rows and columns of the matrix. Such row-based and column-based relationships correspond to inherent structural organization of matrix-based data derived from real-world measurements, including spatial relationships in images, temporal or sequential relationships in data arrays, or dimensional relationships in sensor measurement matrices.

The intra-matrix regularization module 150 is configured to generate regularization information that constrains reconstruction of missing data entries based on internal matrix structure. By explicitly incorporating row-based and column-based relationships into the recovery process, the regularization information discourages reconstruction results that violate inherent structural continuity within a matrix, thereby stabilizing recovery behavior in regions affected by missing data.

The intra-matrix regularization module 150 is particularly effective in scenarios involving structural missingness, such as cases where entire rows or columns of a matrix are missing. In the absence of internal structural constraints, recovery processes may converge to trivial or distorted solutions that satisfy low-rank assumptions while failing to preserve meaningful data structure. The intra-matrix regularization module 150 mitigates such effects by enforcing internal consistency along matrix dimensions during reconstruction.

In operation, the intra-matrix regularization module 150 generates intra-matrix regularization outputs based on analysis of the structured data received from the matrix and tensor structuring module 130. The regularization outputs characterize internal structural constraints associated with rows and columns of each matrix and are provided to the reconstruction update module 160 as input for updating reconstructed matrix data.

The intra-matrix regularization module 150 may further be configured to adapt regularization behavior based on intermediate reconstruction results generated by the reconstruction update module 160. In such configurations, the intra-matrix regularization module 150 cooperates with the reconstruction update module 160 to adjust internal structural constraints as reconstruction progresses, thereby enabling stable and consistent recovery of data entries in structurally incomplete regions.

By explicitly incorporating intra-matrix structural constraints into the data recovery pipeline, the intra-matrix regularization module 150 provides a technical improvement over conventional recovery approaches that rely primarily on global low-rank assumptions or cross-instance correlations alone. The combined use of intra-matrix regularization and inter-matrix correlation processing enables the structural data recovery processing system 100 to preserve meaningful internal data structure while restoring missing rows or columns that cannot be reliably recovered using single-strategy techniques.

The reconstruction update module 160 is a core functional module of the structural data recovery processing system 100 and is configured to generate and update reconstructed matrix data based on information provided by other functional modules of the second functional layer. The reconstruction update module 160 is communicatively coupled to the inter-matrix correlation processing module 140 and the intra-matrix regularization module 150, and cooperates with these modules to perform reconstruction of missing data entries.

In operation, the reconstruction update module 160 receives inter-matrix correlation outputs generated by the inter-matrix correlation processing module 140 and intra-matrix regularization outputs generated by the intra-matrix regularization module 150. The reconstruction update module 160 integrates the received information to update reconstructed matrix data in a manner that accounts for both cross-matrix relationships and internal structural constraints of individual matrices.

The reconstruction update module 160 is configured to perform reconstruction updates iteratively rather than as a single-pass operation. During each update cycle, the reconstruction update module 160 modifies reconstruction variables associated with missing data entries based on current correlation information and regularization constraints, thereby progressively refining reconstructed matrix data toward a stable reconstruction result.

The reconstruction update module 160 is further configured to store intermediate reconstruction results and updated matrix data in the memory module 104, thereby maintaining system state across multiple update cycles. The stored intermediate results may be accessed by the inter-matrix correlation processing module 140 and the intra-matrix regularization module 150 to support adaptive refinement of correlation representations and structural constraints as reconstruction progresses.

In embodiments involving structurally missing data regions, such as missing rows or columns, the reconstruction update module 160 cooperates with the inter-matrix correlation processing module 140 to incorporate information derived from other matrices, and cooperates with the intra-matrix regularization module 150 to preserve internal matrix structure during reconstruction. Through such coordinated operation, the reconstruction update module 160 mitigates reconstruction artifacts that may arise when either cross-matrix information or internal structural constraints are applied in isolation.

The reconstruction update module 160 provides updated reconstructed matrix data as output to one or more functional modules of the third functional layer for execution control, termination determination, and output processing. By enabling iterative integration of inter-matrix correlation information and intra-matrix structural constraints, the reconstruction update module 160 facilitates practical implementation of structural data recovery processing within the structural data recovery processing system 100.

By coordinating and executing reconstruction updates based on multiple sources of structural information, the reconstruction update module 160 provides a technical improvement over conventional reconstruction approaches that rely on single-pass processing or isolated constraint application. The reconstruction update behavior of the module 160 enables the structural data recovery processing system 100 to reliably generate reconstructed data outputs in scenarios involving complex and structurally incomplete matrix-based data sets.

The third functional layer of the structural data recovery processing system 100 includes the iterative optimization control module 170, the convergence and termination determination module 180, and the output interface 190. The functional modules of the third functional layer are communicatively coupled to the functional modules of the second functional layer and are configured to manage execution control, determine completion of data recovery processing, and provide reconstructed data outputs generated by the structural data recovery processing system 100.

The iterative optimization control module 170 is configured to control execution of reconstruction update operations performed by the reconstruction update module 160. The iterative optimization control module 170 coordinates repeated execution of reconstruction updates by managing iteration sequencing, execution timing, and access to system resources under control of the processor 102. By controlling iterative execution, the iterative optimization control module 170 enables progressive refinement of reconstructed matrix data rather than relying on single-pass processing.

The convergence and termination determination module 180 is communicatively coupled to the iterative optimization control module 170 and the reconstruction update module 160, and is configured to determine whether a termination condition for the structural data recovery process is satisfied. The termination condition is determined based on observable system states generated during execution of reconstruction updates.

In some embodiments, the termination condition is determined based on stability of reconstructed matrix data across successive update cycles, such as when changes in reconstructed data fall below a predefined threshold. In other embodiments, the termination condition is determined based on convergence behavior of reconstruction variables stored in the memory module 104, completion of a predetermined number of update iterations, or satisfaction of one or more predefined recovery criteria. Upon determining that the termination condition is satisfied, the convergence and termination determination module 180 signals the iterative optimization control module 170 to stop further reconstruction updates and to transition the structural data recovery processing system 100 to a completed operational state in which reconstructed data outputs are provided for practical use.

The output interface 190 is configured to receive reconstructed data outputs generated by the reconstruction update module 160 upon completion of the data recovery process and to provide the reconstructed data outputs in a tangible form. The output interface 190 may output reconstructed digital images, reconstructed image sequences, recovered measurement matrices, or other reconstructed data products for storage, display, transmission, or further processing by external systems.

Through coordinated operation of the functional modules of the third functional layer, the structural data recovery processing system 100 transitions from iterative reconstruction processing to a completed operational state in which reconstructed data outputs are made available for practical use. The third functional layer thereby facilitates controlled execution, reliable termination, and tangible output of structural data recovery processing performed by the structural data recovery processing system 100.

Through coordinated operation of the processor 102 and the plurality of functional modules, the structural data recovery processing system 100 is configured to perform data recovery tasks by jointly processing incomplete matrix-based data. In operation, the structural data recovery processing system 100 receives one or more input data sets containing missing data entries via the data receiver 110, identifies observed data entries and missing data entries through the observation and mask handling module 120, and organizes the received data into a structured multi-matrix or tensor-like representation using the matrix and tensor structuring module 130. The structured data is processed by the inter-matrix correlation processing module 140 to extract correlations across multiple matrices, and by the intra-matrix regularization module 150 to characterize internal structural relationships within individual matrices. Based on outputs generated by the inter-matrix correlation processing module 140 and the intra-matrix regularization module 150, the reconstruction update module 160 updates reconstructed matrix data under control of the iterative optimization control module 170. The convergence and termination determination module 180 determines whether a termination condition for the data recovery process is satisfied, and upon completion, the output interface 190 outputs reconstructed matrix data, recovered images, recovered image sequences, or other restored data products in a tangible form suitable for storage, display, transmission, or further processing.

In some embodiments, the structural data recovery processing system 100 operates on input objects that are structurally incomplete due to missing data entries and produces corresponding reconstructed output objects in which such structural deficiencies are reduced or eliminated. For example, an input object may include a digital image in which entire rows, columns, or contiguous regions of pixel data are missing, and the output object may include a reconstructed digital image in which the missing pixel regions are restored based on multi-matrix recovery processing. In other embodiments, an input object may include a sequence of image frames forming a video data set in which one or more frames contain structurally missing regions or missing scan lines, and the output object may include a reconstructed image sequence in which the missing regions within individual frames are recovered to produce a visually continuous video sequence. In further embodiments, an input object may include a matrix-based data set representing measurements from a physical sensing system, in which entire rows or columns corresponding to specific sensors, time intervals, or measurement dimensions are missing, and the output object may include a reconstructed measurement matrix in which the missing rows or columns are restored to provide a more complete representation of the underlying physical or measured phenomenon.

Furthermore, the disclosed structural data recovery processing system is not limited to an abstract mathematical formulation, but is realized as a concrete processing architecture comprising interconnected functional modules, memory resources, and control logic executed by physical processing hardware. In operation, real-world matrix-based data sets are physically received by the system, processed through coordinated multi-matrix recovery operations, and delivered as reconstructed data outputs in a tangible form suitable for storage, display, transmission, or further processing. Accordingly, the present disclosure establishes a practical and scalable system framework for recovering structurally incomplete data sets in applications involving image processing, video processing, sensor data analysis, and other matrix-based data processing scenarios, while maintaining compatibility with physical implementation constraints and operational requirements of real-world computing systems.

Accordingly, the present disclosure provides a multiple matrix completion framework, referred to as MMC, configured to recover structurally missing data entries across multiple matrix-based data sets. By jointly modeling inter-matrix correlation through tri-factorization across matrices and inner-matrix correlation through regularization applied to each individual matrix, the disclosed framework overcomes limitations associated with conventional matrix completion and tensor completion techniques. The disclosed approach does not rely on smoothness assumptions across matrices, thereby maintaining robustness under heterogeneous or irregular data conditions. Through an iterative optimization process, reconstructed matrix data are generated and output, wherein at least a portion of the structurally missing data entries are restored to form a more complete representation of the original data sets. As demonstrated through representative application scenarios such as image inpainting and video restoration, the disclosed framework provides improved recovery performance for data sets exhibiting random missingness, structural missingness, or combinations thereof, thereby establishing practical utility and technical advantages over existing completion-based solutions.

The functional units and modules of the apparatuses, systems, and/or methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, and mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A structural data recovery processing system for physically processing real-world matrix-based data and restoring structurally missing data elements, comprising:
a data receiver configured to receive one or more incomplete matrix-based data sets containing missing data entries;
an observation and mask handling module communicatively coupled to the data receiver and configured to identify observed data entries and missing data entries within the received incomplete matrix-based data sets to generate identification information;
a matrix and tensor structuring module communicatively coupled to the observation and mask handling module and configured to organize the received incomplete matrix-based data sets into a structured multi-matrix representation in response to the identification information;
an inter-matrix correlation processing module communicatively coupled to the matrix and tensor structuring module and configured to extract correlation information across multiple matrices from the structured multi-matrix representation;
an intra-matrix regularization module communicatively coupled to the matrix and tensor structuring module and configured to characterize internal structural relationships within individual matrices based on matrix-level data from the structured multi-matrix representation;
a reconstruction update module communicatively coupled to the inter-matrix correlation processing module and the intra-matrix regularization module and configured to receive the extracted correlation information and the characterized internal structural relationships so as to generate reconstructed matrix data based thereon via one or more reconstruction updates; and
an output interface communicatively coupled to the reconstruction update module and configured to output the reconstructed matrix data in a tangible form suitable for storage, display, or transmission.

2. The structural data recovery processing system of claim 1, further comprising:
an iterative optimization control module communicatively coupled to the reconstruction update module and configured to control repeated execution of reconstruction updates performed by the reconstruction update module; and
a convergence and termination determination module communicatively coupled to the iterative optimization control module and the reconstruction update module and configured to determine whether a termination condition for a data recovery process is satisfied, wherein the output interface is further configured to output the reconstructed matrix data after repeated reconstruction updates performed under control of the iterative optimization control module.

3. The structural data recovery processing system of claim 2, wherein the iterative optimization control module is further configured to manage iteration sequencing and execution timing of the reconstruction update module during the data recovery process.

4. The structural data recovery processing system of claim 2, wherein the termination condition is determined based on stability of reconstructed matrix data across successive reconstruction updates.

5. The structural data recovery processing system of claim 2, wherein the inter-matrix correlation processing module is further configured to generate a shared correlation representation based on the structured multi-matrix representation received from the matrix and tensor structuring module, such that information from one matrix contributes to recovery of missing data entries in another matrix.

6. The structural data recovery processing system of claim 5, wherein the inter-matrix correlation processing module is configured to iteratively update the extracted correlation information based on intermediate reconstruction results generated during the one or more reconstruction updates.

7. The structural data recovery processing system of claim 1, wherein the intra-matrix regularization module is configured to apply row-based and column-based structural constraints to matrix-level data received from the matrix and tensor structuring module to preserve internal structure of each matrix during reconstruction.

8. The structural data recovery processing system of claim 1, wherein the intra-matrix regularization module is configured to mitigate reconstruction artifacts associated with structurally missing rows or columns.

9. The structural data recovery processing system of claim 1, wherein the reconstructed matrix data output by the output interface comprises reconstructed digital images, reconstructed image sequences, or reconstructed measurement matrices corresponding to real-world data.

10. A structural data recovery method for physically processing real-world matrix-based data and restoring structurally missing data elements, comprising:
identifying, by an observation and mask handling module, observed data entries and missing data entries within incomplete matrix-based data sets to generate identification information;
organizing, by a matrix and tensor structuring module, the incomplete matrix-based data sets into a structured multi-matrix representation in response to the identification information;
extracting, by an inter-matrix correlation processing module, correlation information across multiple matrices from the structured multi-matrix representation;
characterizing, by an intra-matrix regularization module, internal structural relationships within individual matrices based on matrix-level data derived from the structured multi-matrix representation;
receiving, by a reconstruction update module, the extracted correlation information and the characterized internal structural relationships so as to generate reconstructed matrix data based thereon via one or more reconstruction updates; and
outputting, by an output interface, the reconstructed matrix data in a tangible form suitable for storage, display, or transmission.

11. The structural data recovery method of claim 10, further comprising:
controlling, by an iterative optimization control module, repeated execution of reconstruction updates performed by the reconstruction update module;
determining, by a convergence and termination determination module, whether a termination condition for a data recovery process is satisfied; and
outputting, by the output interface, the reconstructed matrix data after repeated reconstruction updates performed under control of the iterative optimization control module.

12. The structural data recovery method of claim 11, further comprising:
managing, by the iterative optimization control module, iteration sequencing and execution timing of the reconstruction update module during the data recovery process.

13. The structural data recovery method of claim 11, wherein the termination condition is determined based on stability of reconstructed matrix data across successive reconstruction updates.

14. The structural data recovery method of claim 11, further comprising:
generating, by the inter-matrix correlation processing module, a shared correlation representation based on the structured multi-matrix representation received from the matrix and tensor structuring module, such that information from one matrix contributes to recovery of missing data entries in another matrix.

15. The structural data recovery method of claim 14, further comprising:
iteratively updating, by the inter-matrix correlation processing module, the extracted correlation information based on intermediate reconstruction results generated during the one or more reconstruction updates.

16. The structural data recovery method of claim 10, further comprising:
applying, by the intra-matrix regularization module, row-based and column-based structural constraints to matrix-level data from the structured multi-matrix representation to preserve internal structure of each matrix during reconstruction.

17. The structural data recovery method of claim 10, further comprising:
mitigating, by the intra-matrix regularization module, reconstruction artifacts associated with structurally missing rows or columns.

18. The structural data recovery method of claim 10, wherein the reconstructed matrix data output by the output interface comprises reconstructed digital images, reconstructed image sequences, or reconstructed measurement matrices corresponding to real-world data.

19. The structural data recovery method of claim 10, further comprising:
inputting the incomplete matrix-based data sets containing structurally missing data entries prior to identifying the observed data entries and the missing data entries by an observation and mask handling module, wherein the reconstructed matrix data outputted by the output interface has at least a portion of the structurally missing data entries in the incomplete matrix-based data sets restored, such that the reconstructed matrix data represents an enhanced and more complete structural representation of the input incomplete matrix-based data sets.
